(19) United States
(12) Patent Application Publication
(10) Pub. No.: US 2004/0242822 A1
(43) Pub. Date: Dec. 2, 2004

(54) Copolymers containing fluorine, method for the production and use thereof

(76) Inventors: Wolfgang Gawrisch, Dusseldorf (DE); Olaf Lammerschop, Krefeld (DE); Christian Kirsten, Burscheid (DE); Martin Moller, Aachen (DE); Michael Kraus, Chur (CH); Uwe Beginn, Eynatten (BE)

Correspondence Address: WOODCOCK WASHBURN LLP, ONE LIBERTY PLACE, 46TH FLOOR, PHILADELPHIA, PA, 19103, US

(21) Appl. No.: 10/826,611

(22) Filed: Apr. 16, 2004

Related U.S. Application Data
(63) Continuation of application No. PCT/EP02/11276, filed on Oct. 9, 2002.

(30) Foreign Application Priority Data
Oct. 16, 2001 (DE) DE 101 50 954.5
Jul. 12, 2002 (DE) DE 102 31 643.0

(51) Int. Cl. C08F 24/00

(52) U.S. Cl. 526/266; 526/319

(57) ABSTRACT

The present invention relates to relates to copolymers containing fluorine, aqueous compositions containing said copolymers, and the use of said copolymers and compositions for surface treatment.

### CROS REFERENCE TO RELATED APPLICATIONS

This application is a continuation of PCT/EP02/11276, filed Oct. 9, 2002, which claims the benefit of DE 101 50 954.5, filed Oct. 16, 2001, and DE 102 31 643.0, filed Jul. 12, 2002.

### FIELD OF THE INVENTION

The present invention relates to fluorine-containing copolymers, optionally aqueous compositions comprising such copolymers, processes for producing such copolymers and also the use of such copolymers and compositions for surface treatment for example for treating hard surfaces or for treating textiles.

### BACKGROUND

Fluorine-containing polymers are notable for their oil- and water-repellent properties, their high thermal stability and their ability to withstand oxidative influences. Surfaces are frequently coated with fluorine-containing polymers if they are to have favorable properties with regard to soiling, or if soil is to be very easy to remove from thus coated surfaces.

A hitherto unsolved problem with the use of fluorine-containing polymers for coating surfaces is the fact that fluorine-containing polymers are generally not very soluble in water and instead have to be dissolved in halogenated volatile solvents or other organic solvents and be applied therefrom. As a result, however, the polymers are in many situations difficult to apply to surfaces, since the processing of halogenated, volatile solvents is often undesirable for economic and ecological reasons.

There are also health reasons which often argue against the use of such halogenated solvents. If the solvents contain halogenated volatile substances, they can be breathed in and damage the lungs. It is also known that direct skin contact with organic solvents or textiles which have been treated with coatings containing organic solvents can also lead to skin irritation and allergies. Especially when such coatings are used to treat textiles which are used for furnishings and apparel, the use of organic solvents for impregnation can have harmful consequences.

In Chemical Abstracts 1997, 739870 (DN 128:14209, Abstract relating to JP 09296134) there is described a pulverulent composition which contains fillers coated with a fluoropolymer. As fluoropolymers there are used copolymers of acrylic or methacrylic esters of fluorinated alcohols with maleic anhydride. The polymers produced by the reported process, however, constitute a mixture of homo- and copolymers, the copolymers having a low molecular weight, a high polydispersity and a considerable variation in their composition. The polymers described are as a whole unsuitable for producing an aqueous solution or emulsion and, what is more, exhibit only inadequate filming properties.

In Chemical Abstracts 1992, 652522 (DN 117:252522, Abstract relating to JP 04120148) there are described fluoropolymers which are polymerized from maleic anhydride and perfluorononenyloxyisopropenylbenzene. The polymers described are used for surface coating from a methyl isobutyl ketone solution together with further compounds.

In Chemical Abstracts 1992, 216472 (DN 116:216472, Abstract relating to JP 03287615) there is described a polymer which is obtainable by reaction of perfluorooctylethyl methacrylate, maleic anhydride, methyl methacrylate and an initiator in xylene, although (3-aminopropyl)trimethoxysilane is added to the reaction mixture after about 10 hours. The polymer described is used for surface coating from a solution in toluene. The possible solutions recited have in common that maleic anhydride units are introduced above all to improve the adhesion of the fluoropolymers. In the case of CA 1992, 216472 the introduction of trimethoxysilanes, which become bound to the fluoropolymer via the maleic anhydride groups as an amide or imide, is said to bring about a chemical fixation.

A problem with the polymers described is that in principle they can only be applied from organic solvents.

Proposals to meet this disadvantage include for example solutions which utilize emulsions of fluoropolymers in water or aqueous solvents. The disadvantage with these solutions is, however, that such emulsions can often only be obtained in stable form by using large amounts of low molecular weight emulsifiers. Such polymer solutions are described for example in “Grundlagen der Textilveredelung, Handbuch der Technologie, Verfahren und Maschinen” by M. Peter and H. K. Rouette, 13th revised edition; Deutscher Fachverlag, Frankfurt 1989 (see chapter 5 and chapter 7.3.2). However, when such emulsions are used for surface coating, the films which are obtainable are on account of the high emulsifier fraction generally not very resistant to water and exhibit a comparatively high tendency to soil.

Another way to produce aqueous emulsions of fluoropolymers is mentioned for example in WO 97/11218. The reference mentions compounds which are obtainable through reaction of a styrene/maleic anhydride copolymer with fluoroalcohols by ring opening and partial esterification of the maleic anhydride. The polymers described can be formulated as aqueous emulsions, but have an unsatisfactory fluorine content. In addition, the scope for varying the ratio of fluorine-containing substituents to carboxyl groups in the disclosed polymers is subject to a restriction to the effect that a ratio beyond 1:1 cannot be achieved. The polymers described in WO 97/11218 are therefore generally unsuitable for producing superior coatings, since it is impossible to achieve a combination of a high fluorine fraction (up to distinctly above 50 mol % of R_{F}, R_{F}=fluorine-containing radicals) with a similar or higher number of hydrophilic carboxyl or carboxylate groups in the manner described there. And there is a further technical disadvantage in that the fluorinated substituents are introduced into the polymer subsequently, with the familiar general disadvantages of a polymer-analogous reaction. Furthermore, the restriction to styrene as a comonomer means that it is generally not possible to produce products having a glass transition temperature in the region of room temperature or below. Moreover, drastic pH conditions are needed for the (dip) baths whereby the fluoropolymers are applied. The pH values in question can vary from 1.5 to 9. Especially pH values below 4 are needed for the polymers to go on to the substrates, and pH values of 2 to 3 are preferred. At pH values below 3, however, surfactants are needed to stabilize the solutions (amount of surfactant 10-100%, preferably 20-50% based on the fluoropolymers).

A further disadvantage of prior art fluorine-containing polymers is that water solubility can essentially no longer be regulated after their production or after an application as a surface coating. This is problematical in particular when a layer comprising a fluoropolymer has to meet particularly high requirements with regard to water resistance.

Owing to the water-, oil- and soil-repellent properties of fluoropolymers, textiles are often subjected to a chemical aftertreatment with fluoropolymers whereby the textile surface is endowed with certain properties, for example an oil- and water-repellent surface coating.

Additional desiderata of textile treatments are coatings which have flame-retardant or biocidal properties, which have a particularly breathable or non-slip effect or which confer low wrinkling.

A frequent problem with the chemical aftertreatment of textile surfaces is the fact that textiles undergoing cleaning are repeatedly exposed to laundering conditions at high temperatures, high alkalinity, high agitation and high chemical concentrations, often to a stronger degree than would be necessary for cleaning. Therefore, the coatings generally do not have a long service life, but frequently have to be reapplied to the textiles.

Another disadvantage is the property of many impregnants especially for surfaces of textiles that the active component coated onto textiles will absorb into the fabric and the soil-, water- and oil-repellent layer on the fabric surface does not survive long.

To restore the water- and soil-repellent properties of a thus treated fabric, the coating is generally renewed at certain intervals in the case of fabrics where the properties obtained through such a coating are desired. However, this frequently involves the use of compounds which are altogether deemed environmentally harmful, so that each renewal of the coating is associated with ecological disadvantages.

### SUMMARY

In one embodiment, the present invention provides copolymers comprising a first polymer having Formula I:

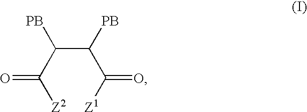

wherein:

PB is a carbon-carbon polymer backbone;

Z¹ and Z² are, independently, OM⁺ or ON⁺(R)₄, wherein M is Na, Li, or K, and R is, independently, H, linear C1-C18 alkyl, an amino sugar, or (CH₂CHR′O)ₘL,

wherein m is an integer from 1 to about 20, R′ is, independently, H or a C1-C24 alkyl radical; and L is H, CH₂CHR′N(R′)₂ or CH₂CHR′N+(R′)₃;

alternatively, Z² is XR″, wherein X is O or NH, and R″ is, independently, H, R, a fluorine-substituted saturated or unsaturated C1-C18 radical, a fluorine-substituted saturated or unsaturated mono or polycyclic C4-C24 radical, or a fluorine-substituted aryl or heteroaryl C6-C24 radical;

alternatively, Z¹ is X′R″ and Z² is X′R^{N}, wherein X′ is O, S or NR′, and R^{N} is, independently, a C2-C25 alkyl radical substituted with at least one amino group or a C5-C25 cycloalkyl radical having at least one amino group;

alternatively, Z¹ and Z² combine to form NR, NR″, or NR^{N};

and a second polymer having Formula II:

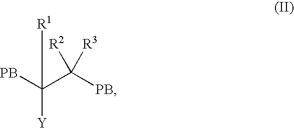

wherein:

R¹, R², and R³ are, independently, H, or C1-C4 alkyl;

Y is R, a fluorine-substituted C1-C24 alkyl radical, a fluorine-substituted cycloalkyl or aryl C6-C24 radical, C(O)OR, a fluorine-substituted C7-C24 alkaryl radical, or a fluorine-substituted alkoxyalkaryl radical, provided that the copolymers contain at least one fluorine-substituted radical.

These and other aspects of the invention, including methods for preparing the copolymers, compositions containing the copolymers, and surface coatings comprising the copolymers, will become more apparent from the detailed description and claims.

### DETAILED DESCRIPTION

The achievement according to the invention can be seen from the patent claims. It substantially comprises improved fluorine-containing copolymers.

There existed therefore a need for fluoropolymers which have a high fraction of fluorine and are soluble or at least emulsible in halogenated solvents, but also in polar solvents, in aqueous polar solvents or in water. There further existed a need for compositions which comprise such fluoropolymers. There further existed a need for fluoropolymers whose water solubility can be further reduced after a surface has been coated. There also existed a need for a process whereby such fluoropolymers can be produced.

There further existed a need for compositions or dispersions comprising highly fluorinated copolymers where adverse health or environmental influences due to the solvent can be substantially ruled out.

There further existed a need for fluorocopolymers which are soluble in water or aqueous polar solvents or in polar organic solvents.

There further existed a need for a coating agent for surfaces especially for surfaces of textiles which ideally does not absorb into the coated fabric, but survives for a very long time as a soil-, water- or oil-repellent layer on the fabric surface.

There additionally also existed a need for a coating agent for surfaces especially for surfaces of textiles which ideally has no adverse environmental and health effects, so that it can also be applied reversibly without adverse repercussions on health or the environment.

There further existed a need for a coating agent whereby soil removal on surfaces, especially on textiles, is facilitated and which is notable for excellent soil-repellent properties.

There also existed a need for a process whereby such coating agents can be produced.

The present invention therefore had for its object to provide fluoropolymers and preparations comprising such fluoropolymers that meet the abovementioned needs. The invention further had for its object to provide a process whereby such fluoropolymers can be produced.

The present invention therefore further had for its object to provide coating agents which meet one or more of the abovementioned needs. The invention further had for its object to provide a process whereby such coating agents can be produced.

It has now been found that copolymers as described in the realm of the following text can have a high fluorine fraction, ensure accurate control of solubility in polar solvents or in an aqueous environment and, when employed as a surface coating, exhibit particularly good water- and soil-repellent properties. It has further been found that the water solubility or water emulsibility of such fluoropolymers, provided they satisfy certain structural conditions, can be further reduced through a simple treatment step, for example after application as a surface coating.

It has further been found that compositions as described in the realm of the following text ensure a simple and safe application of fluorine-containing compounds and lead to surface coatings which exhibit particularly good water- and soil-repellent properties. It has further been found that fluorocopolymers which comprise a nitrogen compound as are described in the realm of the following text are suitable for impregnation of textiles and lead to impregnations having excellent properties.

The present invention accordingly provides a fluorine-containing copolymer at least comprising a structural element of the general formula I

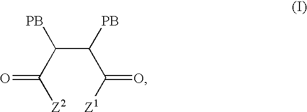

wherein PB represents a polymer backbone having continuous covalent C—C bonds, wherein the radicals Z¹ and Z² each independently represent O⁻M⁺ or O⁻N⁺R₄, where M represents Li, Na or K and R represents H or a linear alkyl radical having 1 to 18 carbon atoms or a radical of the general formula —(CH₂—CHR′—O—)ₘL, wherein m represents an integer from 1 to about 20 and L represents H, CH₂—CHR′—NR′₂ or CH₂—CHR′—N⁺R′₃ or R represents an amino sugar such as aminosorbitol, β-D-glucopyranosylamine or β-D-glucosamine, or one of the radicals Z¹ and Z² represents O⁻M⁺ or O⁻N⁺R₄ and the remaining radical Z¹ or Z² represents X—R″, wherein X represents O or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R or the radicals Z¹ and Z² together represent NR″, or at least Z¹ or at least Z² represents X—R^{N}, wherein X represents O, S or NR′, R^{N} represents a linear or branched alkyl radical having 2 to 25 carbon atoms and at least one amino group or a cycloalkyl radical having 5 to 25 carbon atoms and at least one amino group, and the remaining radical Z¹ or Z² represents X′—R″, wherein X′ represents O, S or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R or Z¹ and Z² together represent NR or wherein the two radicals Z¹ and Z² together represent N—R^{N}, or two or more identical or different structural elements of the general formula I,

and a structural element of the general formula II

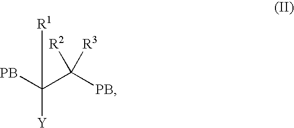

wherein the radicals R¹ to R³ represent H or a linear or branched alkyl radical having 1 to 4 carbon atoms, Y represents R or a linear or branched, optionally fully or partially fluorine-substituted linear or branched alkyl radical having 1 to 24 carbon atoms, an optionally fully or partially fluorine-substituted cycloalkyl radical or aryl radical having 6-24 carbon atoms, a radical of the general formula C(O)OR, an optionally fully or partially fluorine-substituted alkaryl radical having 7 to 24 carbon atoms or an optionally fully or partially fluorine-substituted alkoxyalkaryl radical, or two or more identical or different structural elements of the general formula II and wherein at least one structural element of the general formula I or II in the copolymer comprises a fluorine-substituted radical and at least one structural element of the general formula II comprises a fluorine substituent when the copolymer comprises a structural element of the general formula I wherein Z¹ represents O⁻M⁺ and Z² represents OR, wherein R comprises a fluorine substituent and none of the radicals Z¹ or Z² represents X—R^{N} in a structural element of the general formula I or the radicals Z¹ and Z² together represent N—R^{N}.

“Copolymer” as used herein is to be understood as meaning a polymer polymerized from at least two different monomers. An inventive copolymer can be polymerized for example from up to about 10 different monomers. In the realm of a preferred embodiment of the present invention, an inventive copolymer is polymerized from two to about five and especially from two, three or four different monomers.

The term “polymer backbone” (PB) as used herein comprehends cases where a structural element of the general formula I is in the chain end position. In those cases, one of the “PB” variables represents the structural unit at the chain end, which is due to the initiator or the quencher or some other terminating reaction, depending on the initiation and termination of the free-radical polymerization.

A copolymer in an inventive composition has in the realm of the present invention a molecular weight of about 3000 to about 1 000 000. In principle, an inventive composition may also comprise copolymers having a molecular weight above the upper limit or below the lower limit. When the molecular weight is below about 3000, however, the filming properties of one of the copolymers deteriorate and when the molecular weight is above 1 000 000, the time needed to dissolve the copolymer may be too long for certain applications.

In the realm of a preferred embodiment of the present invention, a copolymer in an inventive composition comprises a molecular weight of about 4000 to about 500 000, for example about 5000 to about 200 000 or about 6000 to about 100 000. Particularly suitable ranges for the molecular weight of the inventive copolymers are for example about 5000 to about 80 000 or about 10 000 to about 25 000.

The term “molecular weight” as used herein is to be understood as meaning the weight average molecular weight (usually abbreviated Mw), unless expressly stated otherwise. The values reported in the realm of the present text are based, unless expressly stated otherwise, on values determined by GPC measurements. The reported values, as are generally customary in the prior art, constitute relative values relative to narrowly distributed calibrating samples. The measurements, insofar as possible with regard to the monomers used for polymerization, were carried out on the copolymers' polymeric precursors which contain still unhydrolyzed maleic anhydride units in place of the comonomeric building blocks (I). These precursors are (depending on the fraction of R_{F}-substituted comonomers) soluble for example in a fluorinated solvent such as Freon 113 or in THF, polymers having a high fraction of fluorine-substituted radicals in the polymer (>50% by weight of radicals having F in the radical) were measured in Freon 113, F₃C—CF₂Cl, polymers having a lower fraction of fluorine-substituted radicals in the polymer (<43% by weight of radicals having F in the radical) were measured in THF. Copolymers having an in-between composition can be measured for example at elevated temperature in THF.

The comparative standard used was either narrowly distributed polystyrene or narrowly distributed polyisoprene samples (for Freon-containing solvents) as obtainable by living anionic polymerization.

The GPC measurements in THF were carried out using a setup comprising a programmable Waters 590 HPLC pump, an arrangement of four Waters μ-Styragel columns (10⁶, 10⁴, 10³, 500 Å) and a Waters 410 refractive index (RI) detector. The flow rate was 1.5 ml/min. Calibration was by means of narrowly distributed polystyrene standards (PSS).

The GPC measurements in Freon were carried out using a setup comprising a programmable Waters 510 HPLC pump, an array of PSS-SDV-XL columns (Polymer Standard Services, PSS, Mainz, 2×8×300 mm, 1×8×500 mm, particle size 5 μm), a Polymer Laboratories PL-ELS-1000 detector and a Waters 486 UV (254 nm) detector. The flow rate was 1.0 ml/min. Calibration was by means of narrowly distributed polyisoprene standards (PSS).

The polydispersity of a copolymer in an inventive composition is for example less than about 10 and especially less than about 7. In the realm of a preferred embodiment of the present invention, the polydispersity of such a copolymer is less than about 5 and especially less than about 4. Exceptionally, the polydispersity of an inventive copolymer can also be less than about 2.5 and for example less than about 2.

An inventive composition may in the realm of the present invention comprise for example just one of the copolymers mentioned above. However, it is similarly envisaged within the realm of the present invention that an inventive composition comprises two or more, for example, three, four or five, different types of the copolymers mentioned above. The term “different types” as used herein relates to the chemical composition of the copolymers or to different molecular weights if the different molecular weights in the case of two polymer types having identical chemical composition would lead to a bimodal distribution of the molecular weights.

An inventive copolymer comprises at least one structural element of the general formula I

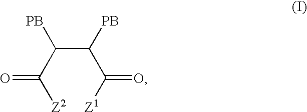

wherein PB represents a polymer backbone having continuous covalent C—C bonds and the radicals Z¹ and Z² each independently represent O⁻M⁺ or O⁻N⁺R₄, where M represents Li, Na or K and R represents H or a linear alkyl radical having 1 to 18 carbon atoms or a radical of the general formula —(CH₂—CHR′—O—)ₘL, wherein m represents an integer from 1 to about 20 and L represents H, CH₂—CHR′—NR′₂ or CH₂—CHR′—N⁺R′₃ or R represents an amino sugar such as aminosorbitol, β-D-glucopyranosylamine or β-D-glucosamine, or one of the radicals Z¹ and Z² represents O⁻M⁺ or O⁻N⁺R₄ and the remaining radical Z¹ or Z² represents X—R″, wherein X represents O or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R or the radicals Z¹ and Z² together represent NR″, or at least Z¹ or at least Z² represents X—R^{N}, wherein X represents O, S or NR′, R^{N} represents a linear or branched alkyl radical having 2 to 25 carbon atoms and at least one amino group or a cycloalkyl radical having 5 to 25 carbon atoms and at least one amino group, and the remaining radical Z¹ or Z² represents X′—R″, wherein X′ represents O, S or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R or Z¹ and Z² together represent NR or wherein the two radicals Z¹ and Z² together represent N—R^{N}, or two or more identical or different structural elements of the general formula I.

The term “polymer backbone” as used herein comprehends cases where a structural element of the general formula I is in the chain end position. In those cases, one of the PB variables represents the structural unit at the chain end, which is due to the initiator or the quencher or some other terminating reaction, depending on the initiation and termination of the free-radical polymerization.

When an inventive copolymer comprises more than one structural element of the general formula I, the two or more structural elements of the general formula I may be identical structural elements, i.e., structural elements of identical chemical construction, or different structural elements of the general formula I. In the realm of a preferred embodiment of the present invention, an inventive copolymer will comprise 1 to about 7 different structural elements of the general formula I, preferably 1, 2, 3 or 4, especially 1 or 2 or 3.

The inventive copolymers are in principle producible by any desired polymerization processes, as long as these polymerization processes lead to the desired polymeric structures. In the realm of a preferred embodiment of the present invention, however, the inventive copolymers are as more particularly described hereinbelow prepared by free-radical polymerization.

A structural element of the general formula I is preferably incorporated in the inventive copolymer by copolymerization of a compound of the general formula III

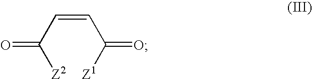

wherein Z¹ and Z² are each as defined above. In the realm of a free-radical polymerization, the olefinically unsaturated double bond of the compound of the general formula III is opened and incorporated in a polymer backbone (PB).

The structural units as per the general formula I may be introduced into the inventive copolymers by using for example compounds of the general formula III wherein one of the radicals Z¹ or Z² or both of the radicals represent O⁻M⁺ or O⁻N⁺R₄. However, it may be preferable in the realm of the present invention to use not the salts as described in the realm of the general formula III but the free acids, for example in order for the polymerization to take place in a hydrophobic (non-aqueous) solvent. In the realm of the present text, therefore, the following description of monomers contemplated for polymerization is to be understood as referring not only to the corresponding alkali metal salts or ammonium salts but also to the free acids, unless expressly stated otherwise.

Useful compounds of the general formula III include in principle maleic acid, the alkali metal or ammonium salts of maleic acid, maleic anhydride and derivatives thereof. Useful derivatives include for example mono- or diesters of maleic acid with suitable monofunctional alcohols and salts thereof, mono- or diamides of maleic acid or cyclomonoamides of maleic acid (maleimides) with ammonia or substituted monoamines. Preferably, in the realm of the present invention, the inventive copolymers are prepared using compounds of the general formula IV which exhibit copolymerization characteristics suitable for producing the inventive copolymers.

The structural elements as per the general formula I are suitably incorporated in the inventive copolymers by using for example compounds of the general formula IV wherein Z¹ and Z² each independently or together represent X—R″, wherein X represents O, N or NH and R″ represents H, a fluorine-substituted linear or branched, saturated alkyl or oxyalkyl radical having 4 to 18 carbon atoms or a fluorine-substituted saturated or unsaturated mono- or polycyclic cycloalkyl radical having 6 to 18 carbon atoms or a fluorine-substituted aryl or hetaryl radical having 6 to 12 carbon atoms.

The structural elements as per the general formula I are particularly suitably introduced into the inventive copolymers by using compounds of the general formula III which are described by the following general structural formulae VII to XII

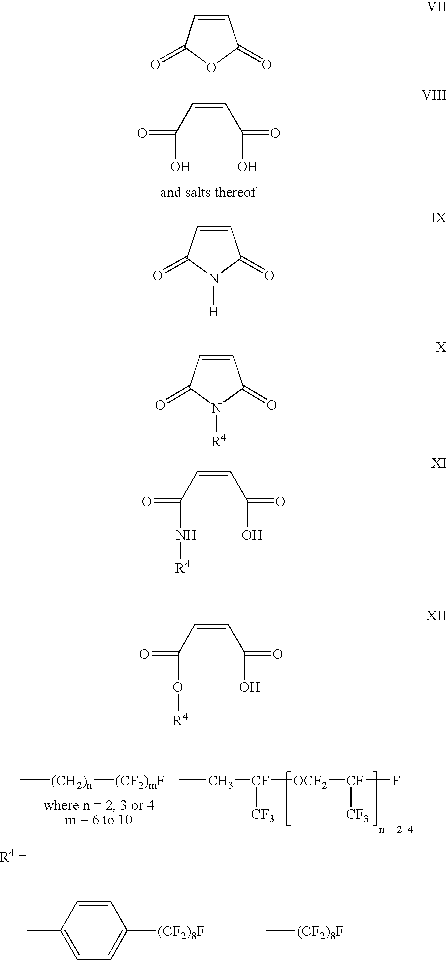

Derivatives of the compounds mentioned above can likewise be used. Examples of suitable compounds of this kind are maleic acid, maleic anhydride, methylmaleic anhydride, 2,3-dimethylmaleic anhydride, phenylmaleic anhydride, maleimide, N-methylmaleimide, N-phenylmaleimide, N-benzylmaleimide, N-(1-pyrenyl)maleimide, 2-methyl-N-phenylmaleimide, 4-phenylazomaleinanil, diethyl fumarate, dimethyl fumarate and corresponding higher aliphatic, cycloaliphatic or aromatic fumaric esters such as dioctyl fumarate or diisobutyl fumarate and also fumaronitrile or mixtures of two or more thereof.

In the realm of a preferred embodiment of the present invention, an inventive copolymer comprises more than just one structural element of the general formula I.

The fraction of the total inventive copolymer which is contributed by structural elements of the general formula I is preferably about 1 to about 50 mol %, especially about 2 to about 50 or about 3 to about 50 mol %. In the realm of a preferred embodiment of the present invention, the fraction of structural elements of the general formula I is chosen such that at least about 5 mol % but preferably more, for example at least about 7 or at least about 10 mol %, of structural units of the general formula I are present in the inventive copolymer. The level of structural elements of the general formula I is preferably for example about 15 to about 50 mol %, especially about 20 to about 50 mol % or about 25 to about 50 mol %. Levels of structural elements of the general formula I that are within these ranges, for example about 30 to about 42 mol % or about 35 to about 39 mol %, are also possible in principle.

In the realm of a preferred embodiment of the present invention, the composition of the copolymer is chosen such that the copolymer, if appropriate after cleavage of an anhydride and neutralization of the free acid groups from the monomeric building blocks, comprises an adequate number of functional groups O⁻M⁺ or O⁻N⁺R₄. The number of functional groups O-M+ or O⁻N⁺R₄ should be such that the copolymer is emulsible in water or polar solvents, for example aprotic polar solvents, or mixtures of water and polar solvents, but preferably in water, at least without addition of major amounts of low molecular weight emulsifiers. Preferably, an inventive copolymer is emulsible by addition of less than about 5% by weight or less than about 3% by weight or less than about 1% by weight of low molecular weight emulsifiers, or even self-emulsible or is essentially molecularly soluble in one of the abovementioned solvents or solvent mixtures.

The fraction of structural units which comprise at least one functional group O⁻M⁺ or O⁻N⁺R₄ is for example at least about 2%, based on the total number of structural units in the inventive copolymer, but preferably the number is higher and is at least about 5, 10, 15 or at least about 20%. The inventive copolymers for example comprise particularly good solubility when the number of structural units having at least one functional group O⁻M⁺ or O⁻N⁺R₄ is more than about 20%, for example more than about 25, 30, 40 or more than about 45%.

The water solubility and also the filming properties of the inventive polymers can also be controlled for example through a suitable choice for the R radicals. For instance, the water solubility can be controlled through the incorporation of suitable R radicals, R being a radical of the general formula —(CH₂—CHR′—O—)ₘL, wherein R′ represents H a linear or branched alkyl radical having 1 to 24 carbon atoms, m represents an integer from 1 to about 20, especially about 1 to about 10 or about 1 to about 5, and L represents H, CH₂—CHR′—NR′₂ or CH₂—CHR′—N⁺R′₃ and R represents an amino sugar such as aminosorbitol, β-D-glucopyranosylamine or P-D-glucosamine. The fraction of R radicals which represent a radical of the general formula —(CH₂—CHR′-O—)ₘL, wherein R′ represents H a linear or branched alkyl radical having 1 to 24 carbon atoms, m represents an integer from 1 to about 20, especially about 1 to about 10 or about 1 to about 5, and L represents H, CH₂—CHR′—NR′₂ or CH₂—CHR′—N⁺R′₃ or represents an amino sugar such as aminosorbitol, β-D-glucopyranosylamine or β-D-glucosamine, is 0 to 4, for example 1, 2 or 3, per structural unit comprising at least one functional group or O⁻N⁺R₄.

In the realm of a further preferred embodiment of the present invention, an inventive copolymer comprises at least one structural element of the general formula I wherein PB represents a polymer backbone having continuous covalent C—C bonds, at least Z¹ or at least Z² represents X—R^{N}, wherein X represents O, S or NR′, R′ represents H a linear or branched alkyl radical having 1 to 24 carbon atoms, R^{N} represents a linear or branched alkyl radical having 2 to 25 carbon atoms and at least one amino group or a cycloalkyl radical having 5 to 25 carbon atoms and at least one amino group, and the remaining radical Z¹ or Z² represents X′—R″, wherein X′ represents O, S or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R, or Z¹ and Z² together represent NR or wherein the two radicals Z¹ and Z² together represent N—R^{N}.

An inventive copolymer can comprise such structural elements of the general formula I in addition to further structural elements of the general formula I, for example the structural elements of the formula I which were mentioned above. However, it is likewise possible for an inventive copolymer to comprise the lastmentioned structural elements of the general formula I as sole structural elements of the general formula I.

Copolymers having the lastmentioned structural elements of the general formula I are particularly useful for surface treatment of fabrics, webs or textiles.

The lastmentioned structural elements as per the general formula I are suitably introduced into the inventive copolymers using compounds of the general formula III wherein Z¹ and Z², as well as having the abovementioned meanings, may additionally combine to represent O. In this case, an inventive copolymer will comprise for example structural elements of the general formula I wherein at least Z¹ or at least Z² represents X—R^{N} or the two radicals Z¹ and Z² together represent N—R^{N} and structural elements of the general formula I wherein the two radicals Z¹ and Z² together represent O. In principle, the abovementioned compounds of the general formula III are therefore maleic anhydride or compounds from the class of the maleic anhydride derivatives.

When in the realm of an inventive copolymer at least one of the radicals Z¹ or Z² represents X—R^{N} or the two radicals Z¹ and Z² together represent N—R^{N}, the structural elements as per the general formula I are suitably introduced into the inventive copolymers using for example compounds of the general formula VIa and VIb

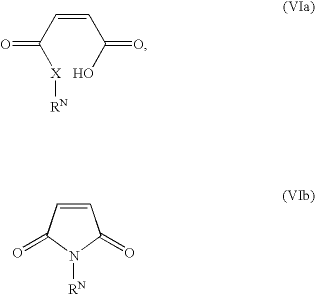

wherein X and R^{N} are each as defined above. The radical R^{N} is in this case a radical which bears at least one amino group.

“Amino group” as used herein is to be understood as meaning in connection with the R^{N} radical mentioned a nitrogen atom which is bound covalently to at least one alkyl group. Such a nitrogen atom, as well as the covalent bond to an alkyl group, may additionally bear two hydrogen atoms for example. However, it is similarly possible for such a nitrogen atom to additionally comprise one or more further covalent bonds to alkyl groups. It is yet further similarly possible for such a nitrogen atom to be part of a mono- or polycyclic system and accordingly to partake with two or three bonds in corresponding cyclic systems. Furthermore, a nitrogen atom designated as an “amino group” herein can bear a positive charge produced for example by addition of a proton or by alkylation (quaternization).

Examples of suitable amino groups are amino groups of the general construction —NH(Alk) or —N(Alk)₂, wherein Alk represents a linear or branched alkyl group having 1 to 4 carbon atoms, especially methyl or ethyl.

In the realm of a preferred embodiment, an inventive copolymer bears a radical R^{N} having an N,N-dialkylamino function, especially an N,N-dimethylamino function. In the realm of a further preferred embodiment of the present invention, the radical R^{N} is a linear alkyl radical having 2 to about 8 and especially 2, 3, 4 or 5 carbon atoms.

In the realm of a preferred embodiment of the present invention, an inventive fluorine-containing copolymer comprises

a) a structural element of the general formula I

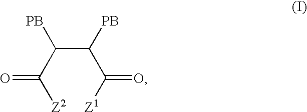

wherein PB represents a polymer backbone having continuous covalent C—C bonds, at least Z¹ or at least Z² represents X—R^{N}, wherein X represents O, S or NR′, R′ represents H a linear or branched alkyl radical having 1 to 24 carbon atoms, R^{N} represents a linear or branched alkyl radical having 2 to 25 carbon atoms and at least one amino group or a cycloalkyl radical having 5 to 25 carbon atoms and at least one amino group, and the remaining radical Z¹ or Z² represents X′—R″, wherein X′ represents O, S or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R, or Z¹ and Z² together represent NR or wherein the two radicals Z¹ and Z² together represent N—R^{N}, and

b) optionally a structural element of the general formula I comprising at least one structural element of the general formula I wherein the radicals Z¹ and Z² each independently stand with O⁻M⁺ or O⁻N⁺R₄, wherein M represents Li, Na or K and R represents H or a linear alkyl radical having 1 to 18 carbon atoms or a radical of the general formula —(CH₂—CHR′—O—)ₘL, wherein R′ represents H or a linear or branched alkyl radical having 1 to 24 carbon atoms, m is an integer from 1 to about 20 and L represents H, CH₂—CHR′—NR′₂ or CH₂—CHR′—N⁺R′₃ or R represents an amino sugar, or one of the radicals Z¹ and Z² represents O⁻M⁺ or O⁻N⁺R₄ and the remaining radical Z¹ or Z² represents X′—R″, wherein X′ represents O or NH and R″ represents H, an optionally fully or partially fluorine-substituted linear or branched, saturated or unsaturated alkyl radical having 1 to 18 carbon atoms or an optionally fully or partially fluorine-substituted saturated or unsaturated mono- or polycyclic cycloalkyl radical having 4 to 24 carbon atoms or an optionally fully or partially fluorine-substituted aryl or hetaryl radical having 6 to 24 carbon atoms or represents R or Z¹ and Z² together represent NR, and

c) a structural element of the general formula II

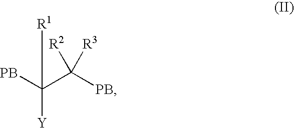

wherein the radicals R¹ to R³ represent H or a linear or branched alkyl radical having 1 to 4 carbon atoms, Y represents R or a linear or branched, optionally fully or partially fluorine-substituted linear or branched alkyl radical having 1 to 24 carbon atoms, an optionally fully or partially fluorine-substituted cycloalkyl radical or aryl radical having 6-24 carbon atoms, a radical of the general formula C(O)OR, an optionally fully or partially fluorine-substituted alkaryl radical having 7 to 24 carbon atoms or an optionally fully or partially fluorine-substituted alkoxyalkaryl radical, or two or more identical or different structural elements of the general formula II and wherein at least one structural element of the general formula II comprises a fluorine substituent if no structural element of the general formula I comprises a fluorine substituent.

An inventive copolymer may in the realm of the present invention bear for example just one structural element of the general formula I type designated above under a), the designation “type” relating to the chemical constitution of the structural element. However, it is similarly possible for an inventive copolymer to bear two or more different types of structural elements of the general formula I type designated under a), for example 3, 4 or 5. Preferably, an inventive copolymer in the realm of the present invention comprises just 1 or 2 structural elements of the general formula I type designated above under a).

The fraction of inventive copolymer which is attributable to structural elements of the general formula I type designated above under a), based on the number of monomers contributing to the copolymer, is for example about 1 to about 50 mol %, especially about 2 to about 50 or about 3 to about 50 mol %. In the realm of a preferred embodiment of the present invention, the fraction of structural elements of the general formula I type designated above under a) is chosen such that at least about 5 mol %, but preferably more, for example at least about 7 or at least about 10 mol % of structural units of the general formula I type designated above under a) are present in the inventive copolymer. Preferably, the level of structural elements of the general formula I type designated above under a) is for example about 15 to about 50 mol %, especially about 20 to about 50 mol % or about 25 to about 50 mol %. Levels of structural elements of the general formula I type designated above under a) that are within these ranges, for example about 30 to about 42 mol % or about 35 to about 39 mol %, are also possible in principle.

The introduction of the structural elements of the general formula I type designated above under a) is accomplished in different ways. For instance, compounds can be copolymerized which without further reaction or optionally after protonation or quaternization lead to an inventive polymer. This method therefore involves reacting compounds with each other which are essentially identical to the above-described structural elements except for the olefinically unsaturated and free-radically polymerizable double bond present in such a compound.

However, it is similarly possible to construct the inventive copolymers initially from compounds which do not as yet have the final structure of the structural elements of the general formula I type designated above under a), but first have to be converted into these structural elements in the realm of a polymer-analogous reaction.

For this it is in principle possible to use all free-radically polymerizable compounds which, in the realm of a polymer-analogous reaction, are capable of reacting with compounds of the X—R^{N} type to form a structural element of the general formula I type designated above under a). Maleic anhydride is particularly suitable.

Such a copolymer with maleic anhydride units can subsequently be converted into structural elements of the general formula I type designated above under a) in the realm of a polymer-analogous reaction with appropriate compounds.

The structural elements of the general formula I type designated above under a) are suitably introduced into the corresponding copolymers comprising maleic anhydride units using for example N,N-dimethylaminoethanol, N,N-dimethylethylenediamine, ethylenediamine, N,N-diethylaminoethanol, 3-dimethylamino-1-propylamine or N,N-diethylethylenediamine.

Suitable reactions and reagents for introducing the further structural elements of the general formula I type described above under a) will be known to one skilled in the art and can for example be introduced into the copolymers analogously to the pattern described here.

An inventive copolymer can in the realm of the present invention comprise for example structural elements of the type designated above under a). In the realm of such an embodiment of the present invention, the composition of the copolymer is chosen such that the fraction of structural elements of the general formula I comprises an about 40 to about 100% fraction of structural elements of the general formula I type designated under a), for example an about 60 to about 95% fraction and more preferably an about 80 to about 90% fraction. However, it is similarly contemplated according to the present invention that an inventive copolymer contains no structural elements of the type designated above under a).

In the realm of a preferred embodiment of the present invention, the composition of the inventive copolymer is chosen such that the copolymer, if appropriate after cleavage of an anhydride and neutralization of the free acid groups from the monomeric building blocks, comprises an adequate number of functional groups O⁻M⁺ or O⁻N⁺R₄. The number of functional groups O⁻M⁺ or O⁻N⁺R₄ should be such that the copolymer is emulsible in water or polar solvents, for example aprotic polar solvents, or mixtures of water and polar solvents, but preferably in water or in the above-described solvent mixture of water and at least one water-miscible alcohol, at least without addition of major amounts of low molecular weight emulsifiers. Preferably, an inventive copolymer is emulsible by addition of less than about 5% by weight or less than about 3% by weight or less than about 1% by weight of low molecular weight emulsifiers, or even self-emulsible or is essentially molecularly soluble in one of the abovementioned solvents or solvent mixtures.

The fraction of structural units which comprise at least one functional group O⁻M⁺ or O⁻N⁺R₄ is for example at least about 2%, based on the total number of structural units in the inventive copolymer, but preferably the number is higher and is at least about 5, 10, 15 or at least about 20%. The inventive copolymers for example comprise particularly good solubility when the number of structural units having at least one functional group O⁻M⁺ or O⁻N⁺R₄ is more than about 20%, for example more than about 25, 30, 40 or more than about 45%.

As well as a structural unit as per the general formula I, an inventive copolymer further comprises at least one structural unit as per the general formula II

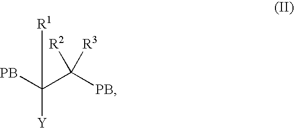

wherein the radicals R¹ to R³ represent H or a linear or branched alkyl radical having 1 to 4 carbon atoms, Y represents R or a linear or branched, optionally fully or partially fluorine-substituted linear or branched alkyl radical having 1 to 24 carbon atoms, an optionally fully or partially fluorine-substituted cycloalkyl radical or aryl radical having 6-24 carbon atoms, a radical of the general formula C(O)OR, an optionally fully or partially fluorine-substituted alkaryl or alkoxyaryl radical having 7 to 24 carbon atoms in total or an optionally fully or partially fluorine-substituted alkoxyalkaryl radical.

Preferably, the radical R¹ in the realm of the present invention represents H or CH₃ and the radicals R² and R³ represent H.

In the realm of a preferred embodiment of the present invention, an inventive copolymer comprises at least one structural element of the formula IV

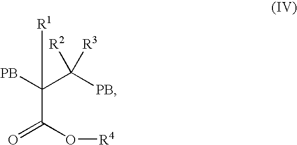

wherein PB, R¹, R², R³ are each as defined above and R⁴ represents R, especially the R″ radicals designated as fluorine substituted in the realm of the description part.

In the realm of a further preferred embodiment of the present invention, an inventive copolymer comprises more than just one structural element of the general formula II. The fraction of total inventive copolymer which is attributable to structural elements of the general formula II is preferably about 50 to about 99 mol %, especially about 50 to about 95 or about 55 to about 85 mol %. There are for example suitable copolymers whose levels of structural elements of the general formula II are about 98 to 52 mol % or about 95 to about 55 mol % or about 90 to about 60 mol %.

A structural element of the general formula I is, as explained above, preferably introduced into the inventive copolymer by free-radical copolymerization. For example, a structural element of the general II is introduced into the inventive copolymer by copolymerization of a compound of the general formula V

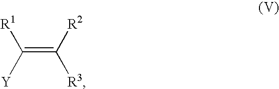

wherein Y, R¹, R² and R³ are each as defined above. In the realm of the free-radical polymerization, the olefinically unsaturated double bond of the compound of the general formula V is opened and incorporated in a polymer backbone (PB). As to the meaning of PB, reference is made to the explanation given above.

Compounds of the general formula V which in the realm of the present invention are suitable for preparing the inventive copolymers suitably include in principle all appropriate monomers which are copolymerizable with a compound of the general formula III or IV. Preferably, however, the inventive copolymers should be prepared using compounds of the general formula V which do not contribute to increased polarity on the part of the copolymer. Particularly suitable compounds of the general formula V are therefore substantially apolar monomers, especially olefins, esters of acrylic acid or methacrylic acid or styrenes. Useful compounds of the general formula V include for example compounds having silyl or fluoroalkyl groups such as trimethylsilyl methacrylate, 2-(trimethylsilyloxy)ethyl methacrylate, 3-(trimethoxysilyl)propyl methacrylate, 2,2,3,3-tetrafluoropropyl methacrylates, 1,1,1,3,3,3-hexafluoroisopropyl methacrylate, 2,2,2-trifluoroethyl methacrylate, 2,2,3,4,4,4-hexafluorobutyl methacrylate, 2,2,2-trifluoroethyl acrylate, 2,2,3,3-tetrafluoropropyl acrylate, 1,1,1,3,3,3-hexafluoroisopropyl acrylate, 2-fluorostyrene, 3-fluorostyrene, 4-fluorostyrene, 3-(trifluoromethyl)styrene, 3,5-bis(trifluoromethyl)styrene or vinyl ethers having long fluorinated side chains.

When the inventive copolymer contains at least one structural element of the general formula I that comprises a fluorine substituent, the inventive copolymers may be prepared using compounds of the general formula V which bear no fluorine substituents. However, it is similarly possible, and contemplated, according to the present invention that an inventive copolymer bear structural elements of the general formula II which comprises fluorine substituents. In this case, such structural element of the general formula II is inserted using compounds of the general formula V which in turn bear fluorine substituents. Compounds of the general formula V which bear such fluorine substituents can be used exclusively. However, it is likewise possible to use mixtures of two or more compounds of the general formula V, in which case not all compounds of the general formula V bear a fluorine substituent. This provides accurate control of the fluorine content and also of the glass and melt transitions and hence also of the solubility and the surface activity of the inventive copolymers.

A preferred embodiment of the present invention utilizes compounds of the general formula V which are fluorine-substituted esters of acrylic acid or fluorine-substituted esters of methacrylic acid or fluorine-substituted styrenes. Particularly suitable compounds in the realm of the present invention have the general formulae XIII to XV

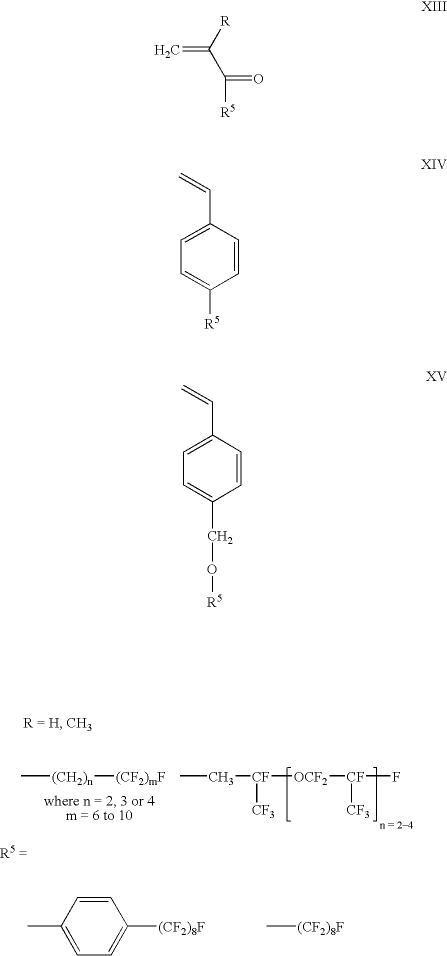

wherein R and R⁵ are each as defined above.

A requirement in the realm of the present invention is that at least one structural element of the general formula I or II in the copolymer comprise a fluorine-substituted radical. However, it is similarly possible, and contemplated, in the realm of the present invention that an inventive copolymer, as well as at least one structural element of the general formula I or of the general formula II that comprises no fluorine substituent, additionally contains structural elements of the general formula I or of the general formula II that comprise no fluorine substituents. Such structural elements can be incorporated in the inventive copolymer by for example using the copolymerization compounds of the general formula IV or V whose radicals Z¹, Z² or Y bear no fluorine substituent. Suitable compounds of this type are for example the compounds of the general formulae VII to XV as depicted above, although the fluorine-substituted R⁵ radicals are replaced by corresponding R⁵ radicals without fluorine substituents. Suitable R⁵ radicals are for example the R⁵ radicals recited in the abovementioned formulae where fluorine is replaced by H in each case.

Copolymers which are particularly suitable in the realm of the present invention comprise for example structural elements of the general formula I which are derived from compounds of the general formula VII, VIII or IX. In the realm of a preferred embodiment of the present invention, inventive copolymers comprise structural elements which are derived from a compound of the general formula VIII.

In the realm of a further preferred embodiment of the present invention, an inventive copolymer, as well as one of the abovementioned structural elements, further comprises a structural element of the general formula II that is derived from a compound of the general formula XIII and comprises a fluorine-substituted radical R⁴.

In the realm of a further preferred embodiment of the present invention, an inventive copolymer comprises structural elements of the general formula I which are derived from compounds of the general formula VIII and XI, wherein the radical R⁵ comprises fluorine substituents. Preferably, in the realm of the present invention, these structural elements are used in combination with structural elements of the general formula II which are derived from a compound of the general formula XIII, XIV or XV, especially XIII or XV.

To avoid the abovementioned disadvantages with regard to too low fluorine content and lack of influence over the water solubility of the inventive copolymers, an inventive copolymer has to comprise at least one structural element of the general formula II having a fluorine substituent when the copolymer contains a structural element of the general formula I wherein Z¹ represents OH and Z² represents OR, wherein R comprises a fluorine substituent unless the copolymer comprises no structural element of the class identified above under a).

The inventive copolymers have a fluorine content which endows surface coatings produced from such copolymers with very good resistance to hydrophilic or hydrophobic compounds, for example water or oil, and very good soil-repellent properties with regard to hydrophilic and hydrophobic soils. The fluorine content of the inventive copolymers is preferably at least about 58% by weight or at least about 52% by weight when the fluorine substituents are introduced not only via compounds of the general formula I and of the general formula II or for example about 10 to about 40% by weight when the fluorinated substituents are introduced solely through compounds of the general formula I.

A particular class of inventive copolymers is constituted by those copolymers which contain a structural element of the general formula I wherein both the radicals Z¹ and Z² represent O⁻N⁺H₄ or one of the radicals Z¹ or Z² represents HN—R and the remaining radical represents O⁻N⁺H₄. Copolymers of this type have by virtue of the ionic groups good emulsibility or solubility in water or aqueous solvents, although the sensitivity of the copolymers to water or aqueous solvents can be reduced after the copolymer has been applied, for example as surface coatings. When such copolymers are deposited on a surface from aqueous solution or emulsions and the resultant layer is dried and thermally treated, these structural elements may by detachment of ammonia and water be converted into structural elements of the general formula XVI or XVII

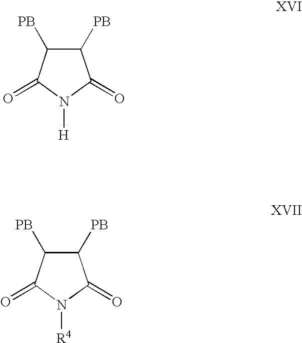

wherein R⁴ is as defined above and the general formula XVI depicts the specific case of R⁴═H. The general formula XVI and XVII depict structural elements of the general formula I wherein the radicals Z¹ and Z² together represent NR. However, these structural elements no longer make any contribution to the solubility or emulsibility of the inventive copolymer in water, aqueous solvents or polar organic solvents, dramatically reducing the sensitivity to the solvents mentioned of a surface coating consisting of or containing such a copolymer.

The inventive copolymers, provided they have functional groups O⁻M⁺ or O⁻N⁺R₄ for example, possess good emulsibility or solubility in water or aqueous solvents. For instance, at least about 0.1% by weight of an inventive copolymer, but preferably more than 0.1% by weight, for example at least about 0.5% by weight or at least about 1% by weight, are emulsible in water or aqueous solvents by addition of less than 5% by weight of low molecular weight emulsifiers, preferably by addition of less than 3% or less than 1% by weight of low molecular weight emulsifiers and more preferably without low molecular weight emulsifiers such that such emulsions remains stable for a period of more than 24 hours, preferably more than 48 hours and preferably more than one week.

The inventive polymers can therefore be dissolved or emulsified in water without addition of a low molecular weight emulsifier for example. Binary copolymers of maleic anhydride and a fluorine-substituted methacrylate (>40 mol % of maleic anhydride) can be made into stable aqueous emulsions having a solids fraction of 50%.

Low molecular weight emulsifiers can be used as a further assistant. They may improve filming to form uniformly thick and homogeneous films. Anionic, cationic and nonionic surfactants are suitable in particular. Cationic surfactants based on quaternary ammonium compounds should be used at most in molar amounts which are below the carboxylate group contents of the inventive polymers. More particularly, surfactants having a fluorine substituent or a siloxane substituent as a hydrophobic constituent can improve filming.

Filming and also emulsibility is further improvable according to the present invention by adding a high-boiling organic component. Examples are perfluorinated ethers or cyclosiloxanes, ketones, alcohols or esters or mixtures of two or more thereof. These components are preferably added in fractions which are less than the weight fraction of the polymer in the emulsion, preferably less than 80% by weight, based on the weight fraction of the polymer in the emulsion.

In the realm of a particularly preferred embodiment of the present invention, inventive copolymers have a water solubility of at least about 0.1% by weight, but preferably a superior water solubility of at least about 0.5% or at least about 1% by weight. The water solubility upper limit is about 75% by weight, for example about 70%, 65%, 60% or 55% by weight. Suitable polymers have for example a water solubility of about 5% to about 60% or about 10% to about 50% or about 15% to about 45% or about 20% to about 40% or about 35% to about 35% by weight, and the water solubility of an inventive polymer can in principle be between upper and lower limits freely chosen within the realm of the disclosure content of the present text.

As well as one or more structural elements as per the general formula I and one or more structural elements as per the general formula II, an inventive copolymer may comprise further structural elements as obtainable from the incorporation of compounds having at least one olefinically unsaturated double bond in the inventive copolymer in the realm of the polymerization reaction leading to the inventive copolymer. For instance, an inventive copolymer may for example contain structural elements as obtainable from the incorporation of nonfluorinated styrenes, acrylates, methacrylates, α-olefins and the like.

In the realm of a preferred embodiment of the present invention, the fraction of such structural elements in an inventive copolymer is up to about 50% (based on the total number of structural elements in the copolymer), for example up to about 20% or up to about 10%.

Examples of further comonomers which are particularly suitable for incorporation of further structural elements of the abovementioned kind are methacrylic acid, methyl methacrylate, ethyl methacrylate, propyl methacrylate, isopropyl methacrylate, n-butyl methacrylate, isobutyl methacrylate, t-butyl methacrylate, n-pentyl methacrylate, isopentyl methacrylate, n-hexyl methacrylate, isohexyl methacrylate, n-heptyl methacrylate, isoheptyl methacrylate, n-octyl methacrylate, isooctyl methacrylate, lauryl methacrylate, tridecyl methacrylate, 2-(methacryloyloxy)ethyl caprolactone, 2-hydroxyethyl methacrylate, hydroxypropyl methacrylate, 4-hydroxybutyl methacrylate, ethylene glycol methyl ether methacrylate, 2-(dimethylamino)ethyl methacrylate, 2-(diethylamino)ethyl methacrylate, glycidyl methacrylate, benzyl methacrylate, stearyl methacrylate, acrylic acid, methyl acrylate, ethyl acrylate, propyl acrylate, isopropyl acrylate, n-butyl acrylate, isobutyl acrylate, t-butyl acrylate, n-pentyl acrylate, isopentyl acrylate, n-hexyl acrylate, isohexyl acrylate, n-heptyl acrylate, isoheptyl acrylate, n-octyl acrylate, isooctyl acrylate, lauryl acrylate, 2-ethylhexyl acrylate, 3,5,5-trimethylhexyl acrylate, isodecyl acrylate, octadecyl acrylate, isobornyl acrylate, vinyl acrylate, 2-hydroxyethyl acrylate, hydroxypropyl acrylate, 4-hydroxybutyl acrylate, ethylene glycol methyl ether acrylate, di(ethylene glycol) ethyl ether acrylate, 2-(dimethylamino)ethyl acrylate, 2-(dipropylamine)propyl methacrylate, di(ethylene glycol)-2-ethylhexyl ether acrylate, 2-(dimethylamino)ethyl acrylate, stearyl acrylate, acrylonitrile, acrylamide, styrene, α-methylstyrene, trans-α-methylstyrene, 2-methyl-1-phenyl-1-propene, 3-methylstyrene, 4-methylstyrene, α-2-dimethylstyrene, 4-tert-butylstyrene, 2,4-dimethylstyrene, 2,5-dimethylstyrene, 2,4,6-trimethylstyrene, 4-vinylbiphenyl, 4-vinylanisole, 4-ethoxystyrene, 2-vinylpyridine, 4-vinylpyridine, vinyl chloride, vinylidene chloride, vinyl acetate, N-vinylpyrrolidone or vinyl fluoride or mixtures of two or more thereof.

The inventive copolymers may contain the structural elements of the general formula I and of the general formula II in the polymer backbone substantially in any desired order, for example in block or random distribution or alternatingly. However, it is preferable according to the present invention for the inventive copolymers to contain the structural elements of the general formula I and of the general formula II in the polymer backbone in random distribution or alternatingly. For instance, the structural elements of the general formula I may be isolated from each other substantially by at least one structural element of the general formula II or some other monomer as listed above. Segments in which the structural elements of the general formula I alternate with another structural element, for example a structural element of the general formula II or a structural element formed from one of the monomers enumerated above, may be present in the polymer backbone of an inventive polymer in any desired order for example in block or random distribution.

In the realm of a preferred embodiment of the present invention, the inventive copolymers comprise the functional groups O⁻M⁺ or O⁻N⁺R₄ in very uniform distribution across the entire polymer backbone. Preferably, a sequence of ten structural elements in the polymer backbone comprises at least one structural element which contains one of the functional groups indicated. Of particular suitability are inventive copolymers in which a sequence of not more than eight or not more than five structural elements comprises at least one such functional group.

The inventive copolymers can in principle be prepared in any desired manner as long as an appropriate polymerization process leads to the desired polymers. For instance, the inventive copolymers can be prepared by simple reaction in a reaction vessel of the monomers which partake in the polymer reaction by the monomers already being present in the reaction vessel at the start of the polymerization in an initial charge composition corresponding to the composition planned for the copolymer.

This approach leads to the inventive polymers in particular when the copolymerization parameters of the monomers involved have been adapted to each other such that the resultant polymers have a substantially identical compositions. This approach is for example successful when one of the monomeric components involved is styrene and the other monomeric component involved is maleic anhydride.

In certain cases, however, a different approach should be chosen to prepare the inventive polymers. This is necessary in particular when the monomers involved in the polymerization have copolymerization parameters such that they are more likely to form homopolymers and substantially no copolymers are formed in the realm of the copolymerization. For instance, copolymers of acrylate or methacrylate esters and maleic anhydride or its derivatives cannot be produced in unitary form in the above-described simple manner by a “one-pot reaction” where the components involved in the reaction are already present at the start of the reaction. In this case, a different reaction path has to be adopted to prepare the inventive copolymers.

It has been determined in the realm of the present invention that copolymers of acrylate or methacrylate esters and maleic anhydride or its derivatives are obtainable when, during the polymerization reaction, the maleic anhydride or its derivatives are present in excess and the acrylate or methacrylate ester is metered into the reaction vessel in the course of the polymerization such that a substantially constant ratio of the mutually reacting components is present throughout the entire polymerization reaction.

The present invention accordingly also provides a process for producing an inventive copolymer, said process comprising at least one monomer of the general formula III

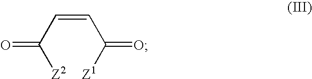

wherein Z¹ and Z² are each as defined above, and a monomer of the general formula V

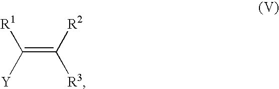

wherein R¹, R², R³ and Y are each as defined above, being copolymerized, wherein the compound or compounds of the general formula IV are present in excess during the copolymerization and the compound or compounds of the general formula V are added dropwise to the reaction mixture during the copolymerization.

Preferably, the feeding of the compound or compounds of the general formula V during the copolymerization in the realm of the inventive process is effected such that a substantially constant ratio of the mutually polymerizing monomers is present throughout the entire polymerization reaction. A corresponding process and its implementation are described hereinbelow.

As already explained above, the inventive polymers can be prepared using compounds of the general formula III and V which bear no functional group O⁻M⁺ or O⁻N⁺R₄. This is even preferable in the realm of the present invention in many cases. In these cases, a polymer produced according to an inventive process has to be provided with appropriate functional groups O⁻M⁺ or O⁻N⁺R₄ for solution or emulsions in water. When a polymer produced in the realm of the inventive process bears anhydride groups for example, appropriate functional groups O⁻M⁺ or O⁻N⁺HR₄ can be introduced into the polymer by the anhydride group being opened by water and the resulting acid groups being neutralized by a basic alkali metal compound or an ammonium compound. Accordingly, polymers bearing acid groups are neutralized with a basic alkali metal compound or an ammonium compound before or during a solution or emulsion in water.

Any basic alkali metal compound is in principle suitable for neutralizing, but the hydroxides especially. Suitable are for example lithium hydroxide, sodium hydroxide or potassium hydroxide in the form of their aqueous solutions. However, ammonium compounds and ammonia especially are particularly suitable and, in the realm of the present invention, preferred. The basic alkali metal compounds or the ammonium compounds are used for organization in the form of their aqueous solutions, the concentration of the aqueous solutions being preferably about 0.1% to about 50% by weight and especially about 0.5% to about 10% by weight.

The inventive copolymers are useful for producing compositions, especially for producing aqueous compositions.

The present invention accordingly also provides a composition at least comprising water and an inventive copolymer or a copolymer produced according to an inventive process.

Such a composition preferably comprises water.

An inventive composition will in such a case comprise for example about 10% to about 99.99% by weight or about 20% to about 99% by weight of water, depending on the field of use of the composition and on the type of the copolymer present in the composition. Suitable compositions have for example a level of inventive copolymer that is in the range from about 0.1% to about 40% by weight, for example in the range from about 0.5% to about 30% by weight or from about 1% to about 20% by weight. When an inventive composition is contemplated to be used as a cream or paste, the level of inventive polymers may exceed the values mentioned and be for example up to about 80% or up to about 70% by weight, for example up to about 60%.

As well as water and one of the abovementioned copolymers or a mixture of two or more thereof, an inventive composition may for example further comprise at least one water-miscible alcohol. With such aqueous-alcoholic solutions or dispersions, the easy and safe handling during application has an advantageous effect on the coating of surface, for example through a simple spraying of the dispersion on the surface to be treated. In addition, particularly uniform layer formation is to be observed.

A preferred solvent mixture in this context consists of water and at least one alcohol. Any desired mixtures of water and one or more different alcohols can be used in principle provided the copolymer or the mixture of two or more copolymers can be dissolved or dispersed in the solvent mixture in a sufficient amount.

Preferred alcohols in the ream of an inventive composition have a water solubility of at least 1 g/l, but preferably at least about 10 or at least about 30 g/l. Suitable alcohols have 1 to about 60H groups, especially about 1, 2 or 3 free OH groups, which can be primary, secondary or tertiary but are preferably primary. Particularly suitable alcohols include linear or branched, saturated or unsaturated or cyclic alcohols having 1 to about 10 carbon atoms, especially linear or branched mono-, di- or triols having 1 to about 6 carbon atoms. Alcohols which are particularly suitable in the realm of a preferred embodiment of the present invention are ethanol, n-propanol, isopropanol, n-butanol, isobutanol, ethylene glycol, propylene glycol, butylene glycol, diethylene glycol, dipropylene glycol, dibutylene glycol, glycerol or trimethylolpropane or mixtures of two or more of the alcohols mentioned above. Also suitable are ether alcohols as obtainable by etherification of one of the abovementioned diols or triols with one of the abovementioned monoalcohols. Particularly suitable are the etherification products of ethylene glycol with ethanol, propanol or butanol, especially ethylene glycol monobutyl ether (butylglycol).

It has additionally been determined that particularly good results are obtainable through the use of a mixture of at least one monoalcohol and at least one ether alcohol. Particularly suitable mixtures here are mixtures of ethanol, n-propanol or isopropanol or a mixture of two or more thereof and ethylene glycol monobutyl ether, propylene glycol monopropyl ether or butylene glycol monoethyl ether or a mixture of two or more thereof, especially mixtures of ethanol and butyl glycol.

When a mixture of monoalcohols and polyols or ether alcohols is employed in the realm of the present invention, the weight ratio of monoalcohols to polyols or ether alcohols will be about 1:100 to about 100:1. It will frequently be advantageous for the monoalcohols to be present in excess in such a mixture. The weight ratio of monoalcohols to polyols or ether alcohols is therefore preferably about 15:1:100 to about 1.1:1, especially about 7:1 to about 1.2:1 or about 4:1 to about 2:1. Particular preference is given to a mixture of ethylene glycol and butyl glycol in a ratio of about 1.2:1 to about 5:1, for example about 1.2:1 to about 2:1 or about 2:1 to about 4:1.

Altogether, the solvent mixture of water and water-miscible alcohol or a mixture of two or more water-miscible alcohols may comprise water in an amount from about 5% to less than 100% by weight, for example in an amount from about 10% to about 99.9% or about 20% to about 95% or about 30% to about 90% or about 35% to about 85% or about 40% to about 80% or about 45% to about 75% by weight.

An inventive composition comprises for example about 20% to about 99.99% by weight of the abovementioned solvent mixture, depending on the field of use of the composition and the type of copolymer present in the composition. Suitable compositions have for example a copolymer content in the range from about 0.01% to about 40% by weight, for example about 0.05% to about 30% by weight or about 0.1% to about 20% by weight or about 0.5% to about 10% by weight. When an inventive composition is contemplated for use as a cream or paste, the level of inventive polymers may exceed the values mentioned and be for example up to about 80% by weight or up to about 70% by weight, for example up to about 60% by weight.

An inventive composition, as well as an inventive copolymer or a mixture of two or more thereof and also optionally water and optionally one or more water-miscible alcohols, may comprise further additives. Examples of suitable further additives are dyes, pigments, fillers, cosolvents, stabilizers, UV stabilizers, antioxidants, wetting agents and the like.

Suitable additives include for example additives to improve the hardness or scratch resistance (Al₂O₃, SiO₂), to deluster the surface (SiO₂, CaCO₃) or to specifically adjust the roughness of a surface treated with the inventive composition (SiO₂). The specific adjustment of the roughness of the surface has for example the purpose to make the wetting behavior of the coated surface particularly water repellent and for example soil repellent. The scratch resistance of a surface treated with an inventive composition is improved by using for example nanoparticles less than about 125 nm in diameter.

It is also possible to use for example further additives which serve to color the formulation for example. Suitable for this purpose are for example water-soluble, ionic dyes, organic and inorganic pigments, sepia, charcoal, SiO₂, TiO₂ (rutile, anatase, brookite), lead white 2PbCO₃.Pb(OH)₂, basic zinc carbonate 2ZnCO₃.3Zn(OH)₃, zinc oxide ZnO, zirconium dioxide ZrO₂, zinc sulfide ZnS, lithopone ZnS/BaSO₄, carbon black, iron oxide black (Fe₃O₄), red iron oxide (Fe₂O₃), apatite 3Ca₃(PO₄)₂.CaF₂, calcium sulfate CaSO₄.2H₂O (gypsum), barium sulfate BaSO₄ (baryte), barium carbonate BaCO₃, calcium silicates or other silicates (e.g., kaolin, talc, mica) or mixtures of two or more thereof.

The fraction of an inventive composition which is attributable to such additives is up to about 50% by weight, preferably 0% to about 30% by weight and more preferably from about 0.5% to about 20% by weight in the realm of the present invention.

Useful additives for improving the wettability of surfaces, especially of metal or plastics surfaces, include customary wetting agents, for example silicone-based wetting agents such as TEGO Wet 280 (Tego Chemie Service, Essen, Germany). Such wetting agents can be present in an inventive composition in an amount from 0% to 5% by weight, for example in an amount from about 0.001% by weight to about 3% by weight.

An inventive composition, as well as the abovementioned solvent mixture of water, one or more water-miscible alcohols and one of the copolymers mentioned above or a mixture of two or more such copolymers and optionally one or more of the additives mentioned above, may further comprise a fluorine-containing polymer or a mixture of two or more fluorine-containing polymers which are not soluble or self-emulsible in water. The fraction of such fluorine-containing polymer is for example up to about 45% by weight (0-45% by weight), but especially up to about 30% or up to about 20% or about 10% or about 5% by weight.

Suitable such fluorine-containing polymers are for example polyacrylate or polymethacrylate esters of fluorinated alcohols, polyacrylamides of fluorinated amines, fluorinated polystyrenes, styrene-(N-fluoro)maleimide copolymers, homo and co polymers of the following compounds:

CF₂═CF₂, CF₃—CF═CF₂,

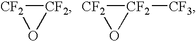

CF₂═CFCl and also polysiloxanes having perfluoroalkyl and perfluoroether substituents.

Solutions or emulsions of the copolymers described, optionally together with one or more of the additives mentioned above and further fluorine-containing polymers, are useful for coating surfaces. It has been determined in this connection that a specific class of the fluorine-containing copolymers described above have particularly outstanding properties in the coating of textile fabrics or in the coating of webs.

An inventive composition comprises for example the following ingredients:

about 20% to about 99% by weight of water

about 0.1% to about 80% by weight of copolymer

about 0% to about 5% by weight of dyes and pigments

about 0% to about 10% by weight of surfactants

about 0% to about 20% by weight of a high-boiling, hydrophobic solvent.

The inventive copolymers, by virtue of their good solubility or emulsibility in water, are further useful as emulsifiers for fluorine-containing polymers which in turn are themselves not soluble or emulsible in water.

Solutions or emulsions of the inventive copolymers, optionally together with one or more of the additives mentioned above and further fluorine-containing polymers, are useful for coating surfaces.

In principle, any desired materials can be coated with the inventive fluoropolymers. Examples of suitable materials are paper, paperboard, glass, metal, stone, ceramic, plastics natural fibers, manufactured fibers, textiles, carpets, wall coverings and the like.

The inventive copolymers are further useful as a constituent of surface-coating compositions of the kind customarily offered in aqueous form, for example as a solution or dispersion. Inventive copolymers are particularly useful as a constituent of emulsion paints which provide a water-insensitive and soil-repellent coating.

Surfaces are coated by spraying, brushing, knife coating or otherwise applying an inventive composition to the surface in question and then drying. The present invention therefore also provides a process for surface coating wherein an inventive copolymer is applied to a surface and subsequently dried.

Preferably, the copolymer is applied to the surface in the form of an inventive composition.

As already explained hereinabove, the inventive copolymers, provided they satisfy certain structural prerequisites, can be influenced, for example by thermal treatment, such that their water solubility or water emulsibility is almost irreversibly reduced. This preferably takes place with ring closure to form the succinimide or anhydride. In the realm of a preferred embodiment of the present invention, the drying of the surface coating in the realm of the inventive process is therefore carried out under conditions where the water solubility or water emulsibility of at least one copolymer in the surface coating decreases compared with its original water solubility or water emulsibility.

Thus coated surfaces exhibit excellent soil repellency. The present invention accordingly also provides a surface which has been coated with an inventive copolymer.

The inventive compositions are useful for example for coating webs, textiles or leather.

Preferred textiles in this connection consist of one or more manufactured fiber types or of one or more natural fiber types or of one or more manufactured fiber types and one or more natural fiber types.

Natural fiber type refers to fibers which have the same source, for example in the case of vegetable source have been obtained from cotton or hemp or linen or some other plant species. In the case of an animal source of a natural fiber, fibers are to be understood as belonging to one fiber type that come for example from the sheep or from the llama or from the rabbit or from some other animal species. In this connection, it is not the individual or business or local source which counts, merely the biological genus of the source organism.

Manufactured fiber type refers to fibers which share a certain basic chemical construction, for example polyester or polyurethane.

As already explained hereinabove, the inventive copolymers, provided they satisfy certain structural prerequisites, can be influenced, for example by thermal treatment, such that their water solubility or water emulsibility is almost irreversibly reduced. This preferably takes place with ring closure to form the succinimide or anhydride. In the realm of a preferred embodiment of the present invention, the drying of the surface coating in the realm of the inventive process is therefore carried out under conditions where the water solubility or water emulsibility of at least one copolymer in the surface coating decreases compared with its original water solubility or water emulsibility.

The water-repellent properties can be further improved, for example, by annealing. Annealing is an operation in which the material is held at a temperature close to, but below the melting temperature of the respective copolymers present in the coating composition in order that frozen-in strains may be relieved.

When textiles are treated with an inventive composition it is for example a heat treatment from 130° C. to 160° C. for 30 sec which has been determined to be advantageous, provided the textiles survive such a temperature for the stated period intact. Annealing was able for example to achieve a contact angle for water on cotton of up to 140° for a coating produced from an inventive copolymer.

Thus coated surfaces exhibit excellent soil repellency. The present invention accordingly also provides a surface which has been coated with an inventive copolymer.

The present invention also provides wovens, textiles and leathers which have each been coated with at least one inventive copolymer. The present invention provides for example natural fibers of one fiber type, manufactured fibers of one fiber type or mixtures of different natural fiber types or mixtures of different manufactured fiber types or mixtures of at least one natural fiber type and at least one manufactured fiber type which have each been coated with at least one inventive copolymer. The present invention also provides all kinds of leather which have been coated with at least one inventive copolymer.

The examples which follow illustrate the invention.

### EXAMPLES

Monomer Synthesis

Materials

1H,1H,2H,2H-Perfluorodecyl methacrylate (Apollo) (passed through column of Al₂O₃ (neutral)); 1H,1H,2H,2H-perfluorodecyl acrylate (Apollo) (passed through column of Al₂O₃ (neutral)); perfluorooctyl iodide (distilled, Hoechst); triethylamine (distilled from CaH₂, Fluka); 2,2′-azobisisobutyronitrile (AIBN) (recrystallized from methanol, Aldrich); 4-iodoaniline (recrystallized from ethanol, Aldrich); sodium hydride (60% suspension in mineral oil, Fluka); 1H,1H,2H,2H-perfluoro-1-decyl iodide (Aldrich); perfluoro-2,5-dimethyl-3,6-dioxanonanoate, methyl perfluoro-2,5,8-trimethyl-3,6,9-trioxadodecanoate (Lancaster); 1H,1H,2H,2H-perfluorodecan-1-ol (Fluorochem); 3-buten-1-ol (Aldrich); p-vinylbenzoyl chloride (Aldrich), tri-n-butyltin hydride (Merck); lithium aluminum hydride (Merck); methyl bromoacetate (Aldrich); 4-vinylbenzyl chloride (Aldrich); (thionyl chloride (Aldrich); sodium azide (Fluka); methyltrioctylammonium chloride (Fluka); tetrabutylammonium hydrogensulfate (Merck); copper bronze (Aldrich); acetic anhydride (Aldrich); sodium sulfate (anhydrous) (Fluka); sodium bicarbonate (Merck); toluene (distilled from sodium/benzophenone, Fluka); xylene (distilled from sodium/benzophenone, Merck); ethyl (diethyl ether) (distilled from sodium/benzophenone, Fluka); THF (distilled from potassium/benzophenone, Fluka); dichloromethane (distilled from P₄O₁₀, Fluka); chloroform (distilled from P₄O₁₀, Fluka); DMF (fractionally distilled from CaH₂); 1,1,2-trichlorotrifluoroethane (Freon 113) (Merck); petroleum ether (Fluka); dimethyl sulfoxide (DMSO) (Fluka).

Unless stated, all reagents were used without further purification.

Synthesis of Hexafluoropropene Oxide Alcohols (HPFOₓOH, x=3, 4, 5)

8 g of lithium aluminum hydride (210.5 mmol) are suspended in 300 ml of tetrahydrofuran in a 500 ml three-neck flask equipped with reflux condenser, drying tube, dropping funnel and KPG stirrer. 70 g of methyl perfluoro-2,5-dimethyl-3,6-dioxanonanoate (136.2 mmol) in 100 ml of tetrahydrofuran are then added drop wise with care (foaming). The reaction batch is then refluxed overnight. After the reaction mixture has cooled down to room temperature, excess lithium aluminum hydride is destroyed by dropwise addition of dilute hydrochloric acid (foaming). The product is extracted three times from the aqueous phase with a mixture of dichloromethane and Freon-113 and the organic phase is washed with dilute hydrochloric acid to destroy the last traces of lithium aluminum hydride. The aqueous phases are combined and extracted once more with dichloromethane/Freon-113. The combined organic phases are dried over sodium sulfate and the solvent is removed in a rotary evaporator. The product is purified by distillation in an oil pump vacuum.

The following compounds were synthesized in this way: 1H,1H-perfluoro-2,5-dimethyl-3,6-dioxanonan-1-ol ((HFPO)₃OH), 1H,1H-perfluoro-2,5,8-trimethyl-3,6,9-trioxadodecan-1-ol ((HFPO)₄OH), 1H,1H-perfluoro-2,5,8,11-tetramethyl-3,6,9,12-tetraoxapentadecan-1-ol ((HFPO)₅OH).

Synthesis of 1H,1H,2H,2H,3H,3H,4H,4H-perfluorododecan-1-ol

A 250 ml three-neck flask equipped with Liebig condenser, rubber septum and a glass stopper is charged with 38.2 g (70 mmol) of perfluorooctyl iodide and 8.6 ml (100 mmol) of 3-buten-1-ol. The mixture is homogenized at 80° C. in an argon atmosphere and 175 mg of AIBN added in small portions over 45 min. On completion of the addition the mixture is stirred at 80° C. for a further 5 h. The product sublimes into the Liebig condenser and can be returned into the reaction flask by knocking the condenser wall. To avoid decomposition of the iodide in the course of a purifying procedure, the crude 1H,1H,2H,2H,3H,3H,4H,4H-3-iodoperfluorododecan-1-ol was directly reduced to 1H,1H,2H,2H,3H,3H,4H,4H-perfluorododecan-1-ol by addition of tri-n-butyltin. 70 ml of toluene and 1.1 g of AIBN are added to the reaction mixture under argon. 37 ml (140 mmol) of tri-n-butyltin are added via a syringe. The flask which is equipped with a reflux condenser is stirred at 80° C. for 18 h. After cooling to 70° C. the mixture is poured into 600 ml of distilled methanol to destroy reactive residues. The methanol is removed and the product recrystallized from toluene.

Chlorination of Fluorinated Alcohols

40 mmol of fluoroalcohol are dissolved in 200 ml of toluene and heated to 80° C. in a 250 ml three-neck flask equipped with reflux condenser, rubber septum and a glass stopper. Then first 40 mmol of triethylamine and thereafter slowly 120 mmol of thionyl chloride are then added dropwise via a syringe. The reaction batch is stirred at 80° C. overnight. After the reaction mixture has cooled down to room temperature, the hydrochloride which has formed is filtered off with suction and the toluene solution is concentrated down to 100 ml. The organic phase is washed twice with 10% aqueous sodium bicarbonate solution and three times with water. The organic phases are dried over sodium sulfate, filtered off, the solvent is removed and the product is distilled twice through a Vigreaux column under reduced pressure. The following compounds were synthesized in this way: 1H,1H,2H,2H,3H,3H,4H,4H-perfluorodecyl chloride, 1H,1H,2H,2H,4H,4H-perfluoro-5,8-dimethyl-3,6,9-trioxadodecyl chloride, ((HFPO)₃OCH₂CH₂Cl), 1H,1H,2H,2H,4H,4H-perfluoro-5,8,11-trimethyl-3,6,9,12-tetraoxapentadecyl chloride ((HFPO)₄OCH₂CH₂Cl). Synthesis of fluoroalkyl azides (phase transfer catalyzed)

A 100 ml flask equipped with Liebig condenser is charged with a 25% aqueous solution of sodium azide (70 mmol) with the phase transfer catalyst (5% of methyltriisooctylammonium chloride per mole of halogen compound) and the fluorohalide (35 mmol). The mixture is stirred at 90-100° C. and the progress of the reaction is monitored by GC. The reaction is discontinued when all halide has been consumed and the aqueous phase is decanted off. Purification of the product is not necessary. The following compounds were synthesized in this way: 1H,1H,2H,2H-perfluorodecyl 1-azide, 1H,1H,2H,2H,3H,3H,4H,4H-perfluorododecyl 1-azide, 1H,1H,2H,2H,4H,4H-perfluo-5,8-dimethyl-3,6,9-trioxadodecyl 1-azide ((HFPO)₃OCH₂CH₂N₃), 1H,1H,2H,2H,4H,4H-perfluoro-5,8,11-trimethyl-3,6,9,12-tetraoxapentadecyl 1-azide ((HFPO)₄OCH₂CH₂N₃).

Synthesis of Fluoroalkylamines

In a 500 ml flask equipped with reflux condenser and dropping funnel 100 ml of an ethereal solution of 10 mmol of fluorinated azide are added dropwise to a suspension of 15 mmol of lithium aluminum hydride in dry ether. The dropwise addition rate is chosen such that the ether boils under reflux and is then refluxed for a further 5 hours. Excess lithium aluminum hydride is destroyed by addition of moist ether, followed by water. The insoluble salts are separated off, the ethereal phase is separated off and the aqueous phase is repeatedly extracted with ether. After drying over sodium sulfate and removing the ether, the product is distilled under reduced pressure. The following compounds were synthesized in this way: 1H,1H,2H,2H-perfluorodecyl-1-amine, 1H,1H,2H,2H,3H,3H,4H,4H-perfluorododecyl-1-amine, 1H,1H,2H,2H,4H,4H-perfluo-5,8-dimethyl-3,6,9-trioxadecyl-1-amine ((HFPO)₃OCH₂CH₂NH₂), 1H,1H,2H,2H,4H,4H-perfluoro-5,8,11-trimethyl-3,6,9,12-tetraoxapentadecyl-1-amine ((HFPO)₄OCH₂CH₂NH₂).

Synthesis of 4-perfluorooctylaniline

In a 100 ml round-bottom flask equipped with reflux condenser a suspension of 5.7 g (26 mmol) of 4-iodoaniline, 15.7 g (28.9 mmol) of perfluorooctyl iodide and 5.5 g (86.7 mmol) of copper bronze in 50 ml of DMSO is heated to 120° C. for 20 h. The hot suspension is filtered to remove excess copper bronze and Cu(I) iodide. 100 ml of ether and 100 ml of distilled water are added and the mixture is stirred for 10 minutes. The organic phase is separated off and washed 3 times with water. After the ether has been removed, the product is distilled.

Synthesis of p-perfluoroalkyl-ethyleneoxymethyl-styrene

The perfluoroalcohol (80 mmol) is dissolved in 160 ml of dichloromethane. To this solution are added 160 ml of 50% aqueous NaOH solution and also 8 mmol of TBAH. 88 mmol of p-vinylbenzyl chloride are added with vigorous stirring, whereupon there is a color change to yellow. After 18 h at 40° C. the orange phase is separated off, washed once with dilute HCl and three times with water and dried over sodium sulfate. Filtration and removal of the solvent leaves brown, oily liquids. Purification is effected by distillation in a high vacuum (C4-perfluorocarbon segment; colorless, oily liquid), column chromatography over silica gel (C6-perfluoro segment; colorless, oily liquid) or by repeated recrystallizing from methanol (C8- and C10-perfluoro segment; colorless solid). The following compounds were synthesized in this way: F(CF₂)₄CH₂CH₂—OCH₂—C₆H₄—CH═CH₂, F(CF₂)₆CH₂CH₂—OCH₂—C₆H₄—CH═CH₂, F(CF₂)₈CH₂CH₂—OCH₂—C₆H₄—CH═CH₂, F(CF₂)₁₀(CH₂)₂—OCH₂—C₆H₄—CH═CH₂

Synthesis of p-oligohexafluoropropene oxide-oxymethyl-styrene (styrene-HFPOₙ)

The perfluoroalcohol (15 mmol) is dissolved in a mixture of 30 ml of dichloromethane and 30 ml of 1,1,2-trichlorotrifluoroethane. 30 ml of 50% by weight aqueous NaOH solution and also 1.5 mmol of TBAH are added to this solution. 16.65 mmol of p-vinylbenzyl chloride are added with vigorous stirring, whereupon a color change to yellow occurs. After 48 h at 40° C. the orange phase is separated off, washed once with dilute HCl and three times with water and dried over sodium sulfate. Filtration and removal of the solvent leaves yellow, oily liquids. The following compounds were synthesized in this way: p-1H,1H-perfluoro-2,5-dimethyl-3,6-dioxanonane-oxymethyl-styrene, p-1H,1H-perfluoro-2,5,8-trimethyl-3,6,9-trioxadodecane-oxymethyl-styrene, p-1H,1H-perfluoro-2,5,8,11-tetramethyl-3,6,9,12-tetraoxapentadecane-oxymethyl-styrene.

Synthesis of 1H,1H,2H,2H-perfluoroalkyl methacrylate

A 250 ml three-neck flask equipped with reflux condenser, nitrogen inlet and rubber septum is charged with 43 mmol of 1H,1H,2H,2H-perfluoroalkyl-1-ol and also 5 mmol of 4-dimethylaminopyridine and purged with nitrogen. 100 ml of freshly distilled dichloromethane and 20 ml of 1,1,2-trichlorotrifluoroethane are added to the flask, followed by the slow dropwise addition of first 40 mmol of methacrylic anhydride followed by 45 mmol of triethylamine through a septum. The solution is stirred at 30° C. for 18 h. This is followed by washing with water, dilute hydrochloric acid, 4% aqueous sodium carbonate solution and again with water. After drying with sodium sulfate and filtration, the solvent is removed to leave a colorless liquid. The monomer is purified over a short column of neutral aluminum oxide (ICN) and molecular sieve (4 Å) and dried. THF is used as mobile phase. The monomer solution in THF is stored at −20° C. over molecular sieve. The following compounds were synthesized in this way: 1H,1H,2H,2H-perfluorohexyl methacrylate.

Synthesis of hexafluoropropene oxide methacrylate (HFPOₓMA, x=3, 4, 5)

In a 250 ml three-neck flask equipped with reflux condenser, nitrogen inlet and rubber septum 31 mmol of HFPOₓOH (x=3, 4, 5) and 3.6 mmol of dimethylaminopyridine are dissolved in a mixture of 75 ml of dichloromethane and 25 ml of 1,1,2-trichlorotrifluoroethane. 30 mmol of methacrylic anhydride followed by 30 mmol of triethylamine are slowly added dropwise through a septum. The solution is stirred at 30° C. for 18 h. This is followed by washing with water, dilute hydrochloric acid, 4% aqueous sodium carbonate solution and again with water. The combined aqueous phases are extracted with dichloromethane/1,1,2-trichlorotrifluoroethane, the organic phases are dried with sodium sulfate and the solvent is removed to leave a colorless liquid. The monomer is purified over a short column of neutral aluminum oxide (ICN) and molecular sieve (4 Å) and dried.

The following compounds were synthesized in this way: 1H,1H-perfluoro-2,5-dimethyl-3,6-dioxadodecyl methacrylate, 1H,1H-perfluoro-2,5,8-trimethyl-3,6,9-trioxa-pentadecyl methacrylate, 1H,1H-perfluoro-2,5,8,11-tetramethyl-3,6,9,12-tetraoxapentadecyl methacrylate.

Copolymerization of Fluorinated Styrene Derivatives with Maleic Anhydride

[image]

Illustration 1: Copolymerization diagram for polymerization of maleic anhydride (MSA) with styrene (Chapman C. B., Valentine L., J. Polym. Sci., 34 (1959) 319)

As illustration 1 shows, styrene copolymerizes alternatingly with maleic anhydride (MSA) in a wide mixing range. Two explanations have been put forward for this behavior. Alternating copolymerization due to polar effects in the resonance stabilization of the free-radical intermediates or due to the formation of charge-transfer complexes between styrene and maleic anhydride. The electron-rich character of styrene and the electron-deficient character of maleic anhydride are pivotal in both cases. The fluorocarbon substituents of the p-perfluoroalkylstyrene polymerized here are sufficiently removed from the aromatic ring system so as not to exert any pivotal effect on the electronic character of the aromatic ring. So an alternating polymerization of maleic anhydride with the perfluoroalkyl-substituted styrene is likely in the present case too.

Experimental Prescription for Polymerization of Perfluoroalkyl-Substituted Styrenes with Maleic Anhydride

Maleic anhydride (4.6 mmol) and styrene-R_{F} (4.6 mmol) are dissolved in 30 ml of ethyl methyl ketone in a 100 ml round-bottom flask with septum. The solvent is devolatilized and flooded with argon to displace oxygen. 31 mg (4 mol %) of AIBN are added followed by purging with argon. The reaction solution is stirred at 60° C. for 9 h. The solvent is removed under reduced pressure, the residue is taken up in chloroform and precipitated in methanol. The polymer is filtered off and dried at 80° C. under reduced pressure. Tables 1 and 2 list examples of the batches and the characterization of the polymers prepared

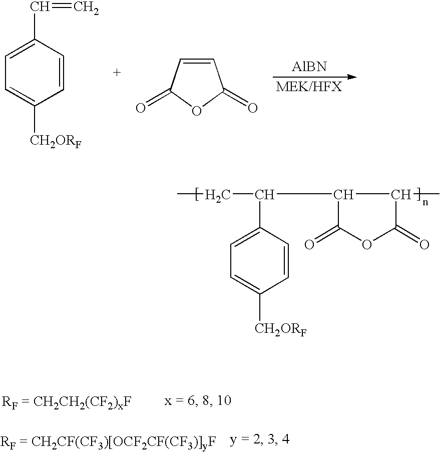

TABLE 1
Batches for free-radical polymerization of perfluoroalkyl-
substituted styrenes with maleic anhydride

| | MSA_{Feed} | Fluoromonomer_{Feed} | AIBN | MEK:HFX |
|---|---|---|---|---|
| Monomer | [mg] | [mg] | [mg] | [parts] |
| Styrene-F₆ | 451 | 2208 | 31 | 5:5 |
| Styrene-F₈ | 451 | 2668 | 31 | 5:5 |
| Styrene-F₁₀ | 451 | 3128 | 31 | 5:5 |
| Styrene-HFPO₄ | 451 | 3514 | 31 | 5:5 |
| Styrene-HFPO₅ | 451 | 4278 | 31 | 5:5 |

The designations F₆ to F₈ relate to the radicals designated with x=6, 8 and 10 in the above formula scheme, whereas the designations HFPO₄ and HFPO₅ relate to styrene types of the radicals with a basic propylene oxide skeleton which are identified with x=2, 3, 4 in the above formula scheme.

TABLE 2
Molecular weights, yields and melting and glass transition temperatures
of fluoroalkylstyrene-maleic anhydride copolymers prepared

| | Mₙ | M_{w} | | MSA^{a}_{act} | Yield | | Tₘ^{b} |
|---|---|---|---|---|---|---|---|
| Copolymer | [kg/mol] | [kg/mol] | M_{w}/Mₙ | [wt-%] | (%) | T_{g}^{b} [° C.] | [° C.] |
| P(Styrene-F₆-co- | 10 | 18 | 1.8 | 43.6 | 85 | 164 | 202 |
| MSA) (THF) | | | | | | | |
| P(Styrene-F₈-co- | 18 | 31 | 1.7 | 46.6 | 89 | 166 | 234 |
| MSA) (Freon) | | | | | | | |
| P(Styrene-F₁₀-co- | 12 | 25 | 2.1 | 52.1 | 88 | 169 | 217 |
| MSA) (Freon) | | | | | | | |
| P(Styrene-HFPO₄- | 54 | 76 | 1.4 | 50.5 | 65 | 50 | — |
| co-MSA) (Freon | | | | | | | |
| P(Styrene-HFPO₅- | 109 | 205 | 1.9 | 53.5 | 70 | — | — |
| co-MSA) (Freon) | | | | | | | |

^{a}Elemental analysis,
^{b}DSC, 2nd heating, 10°/min

Wetting Behavior of Thin Films of Styrene Copolymers

To enable the oil- and water-repellent properties of the copolymers to be compared, thin films of the polymers were spun coated onto glass platelets from a 1 wt-% solution (HFX, 1:1 HFX/THF) for surface characterization. Deposition from an organic, apolar solution encourages the fluorine groups to become oriented toward the surface. Clear films were obtained in all cases. The samples were annealed at 150° C. for 2 h. The wettability of these films by a series of n-alkanes was determined according to the statistical method of the sessile drop. A G40 goniometer from Krüss with temperature control chamber, G1041 video measuring system and PDA 10 software was used. The values for the critical surface tension γc were determined by means of the Zisman equation¹ (cos Θ=1+m(γL−γc) and after Girifalco-Good-Fowkes-Young² (cos Θ=−1+2(γSD)1/2 γL−1/2) (illustration 2 and illustration 3).

[image]

1: W. A. Zisman in Contact Angle, Wettability and Adhesion, Adv. In Chemistry Series Vol. 43, R. F. Gould (ed.), American Chemical Society, Washington, D.C., 1964

2: F. M. Fowkes, J. Phys. Chem., 66 (1962) 382; F. M. Fowkes, Ind. Eng. Chem., 56 (1964) 40; L. A. Girafalco, R. J. Good, J. Phys. Chem., 61 (1957) 904

Illustration 2: Zisman plot for P(StyFₓ-alt-MSA) polymers having different fractions of MSA (maleic anhydride) in the polymer. Wetting liquids: n-hexadecane (γ_{L}=27.6 mN/m), n-dodecane (γ_{L}=25.1 mN/m), n-decane (γ_{L}=24.0 mN/m), n-octane (γ_{L}=21.8 mN/m), applied from 1:1 THF/HFX

All the polymers measured have very low surface tensions which are evidence of the fluorinated side groups being oriented toward the surface (table 3). The values decrease with increasing perfluoroalkyl chain length.

[image]

Illustration 3: GGFY plot for P(StyFx-alt-MSA) polymers having different fractions of MSA (maleic anhydride) in the polymer. Wetting liquids: n-hexadecane (γ_{L}=27.6 mN/m), n-dodecane (γ_{L}=25.1 mN/m), n-decane (γ_{L}=24.0 mN/m), n-octane (γ_{L}=21.8 mN/m)

TABLE 3
Critical surface tension γ_{c} (after Zisman) and dispersive
component of the surface energy γₛ^{D} (after GGFY)
and also the contact angles against hexadecane of the films
deposited from 1:1 HFX/THF solution and annealed at 150° C.

| | | | | ^{θ}hexadecane |
|---|---|---|---|---|
| | γ_{c} | γₛ^{D} | ^{θ}hexadecane | 2 h/150° C. |
| Polymer | [mN/m] | [mN/m] | [degrees] | [degrees] |
| P(StyF10-alt-MSA) | 10 | 10 | 81 | 78 |
| P(StyF8-alt-MSA) | 14 | 14 | 67 | 73 |
| P(StyF6-alt-MSA) | 16 | 15 | 60 | 71 |
| P(Styrene-HFPO₄-co- | 9 | 12 | 76 | 75 |
| MSA) | | | | |
| P(Styrene-HFPO₅-co- | 8 | 11 | 78 | 78 |
| MSA) | | | | |

Owing to the high glass transition temperatures and the melt transitions, maximum oil and water repellency could in some cases only be achieved after annealing. This was not the case for those polymeric compounds where instead of a perfluoroalkyl radical an HFPO oligomer was introduced as a substituent of the styrene units.

Preparation of Aqueous Emulsions of P(Sty-R_{f}-co-MSA)

Owing to the high glass transition temperatures and the melt transformation, relatively high temperatures are often needed to dissolve/emulsify the polymers. In some instances the emulsions can only be prepared under pressure, for example by means of a high-pressure homogenizer (Avestin, Heidelberg). The addition of a small amount of a fluorinated solvent (HFX, perfluorodecalin) on the order of the weight of fluoropolymer used can distinctly improve the emulsibility.

Experimental Prescription:

P(StyF6-alt-MSA) (400 mg) are admixed with 4 ml of aqueous 10% ammoniacal solution and stirred at 60° C. Excess ammonia is subsequently driven off at 50° C. and the mixture is homogenized using an Emulsiflex C5 at about 1000 bar for a few minutes to give a milkily cloudy, foaming emulsion. Unemulsified fractions amount to less than 5% of the weight of material used and can be separated off by filtration. The emulsions are stable for weeks.

Coating of a Substrate with the Emulsions and Measuring the Wettability of the Layers (Contact Angle Measurements)

A thin film of 1% by weight aqueous solution of P(StyF6-alt-MSA) was spun coated onto a glass platelet and subsequently annealed at 120° C. for 11 hours. The wettability of these films by a series of n-alkanes was determined according to the method of the sessile drop. A G40 goniometer from Krüss with temperature control chamber, G1041 video measuring system and PDA 10 software was used. The values for the critical surface tension γc were determined by means of the Zisman equation (cos Θ)=l+m(γ_{L}−γ_{c})) and after Girifalco-Good-Fowkes-Young (cos Θ)=−1+2(γ_{S}^{D})^{1/2} γ_{L}^{-1/2}). The value corresponds to that of the annealed sample deposited from HFX.

| | γ_{c} | γ_{c}^{D} | ^{θ}hexadecane |
|---|---|---|---|
| Polymer | [mN/m] | [mN/m] | [degree] |
| P(StyF6-alt-MSA) from water | 9 | 12 | 72 |

Copolymerization of Acrylates/Methacrylates with Maleic Anhydride

The copolymerization of acrylates and methacrylates with maleic anhydride (MSA) takes place with preferential incorporation of the acrylates and methacrylates. This means that it is not possible to obtain a unitary product when all the monomers are present at the start of the polymerization. Methacrylates and acrylates having perfluoroalkyl substituents can differ fundamentally from nonfluorinated methacrylates/acrylates in their copolymerization behavior.

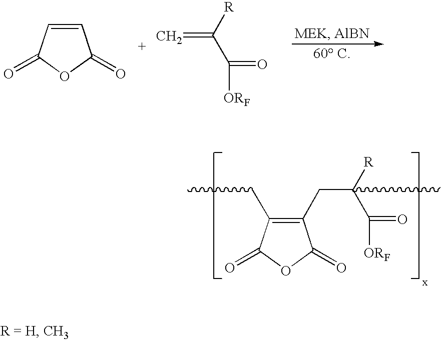

Determination of Copolymerization Parameters for P(MSA-co-F8H2MA)

AIBN (4 mol %), maleic anhydride and fluorinated methacrylate monomer are dissolved in 20 ml of a 1:1 mixture of ethyl methyl ketone and a fluorinated cosolvent in a two-neck flask. The solvent is devolatilized by repeated freezing, evacuating and thawing. A septum through which samples can be taken is substituted for one stopper under a countercurrent nitrogen stream. The r_{MSA} and r_{F monomer} copolymerization parameters were determined by polymerizing various monomer fractions of maleic anhydride and MMA-F8H2 to small conversions (<10% by weight) and determining their composition by ¹H NMR (table 4).

TABLE 4
Feed composition and maleic
anhydride (MSA) content in polymer in mol %

| MSA | F8H2MA | MSA^{a}_{polymer} |
|---|---|---|
| 25 | 75 | 8 |
| 50 | 50 | 15 |
| 75 | 25 | 30 |
| 90 | 10 | 40 |

^{a}¹H NMR

The copolymerization parameters were determined by fitting the copolymerization equation (1) the experimentally determined data points.

$${F}_{MSA} = \frac{{T}_{MAS} \cdot {f}_{MSA}^{2} + {f}_{MSA} \cdot {f}_{{F}_{6} {R}_{2} MA}}{{T}_{MSA} \cdot {f}_{MSA}^{2} + 2 \cdot {f}_{MSA} \cdot {f}_{{F}_{8} {H}_{2} MA} + {T}_{{F}_{8} {H}_{2} MA} \cdot {f}_{{F}_{8} {H}_{2} MA}^{2}} \qquad ( 1 )$$

[image]

Illustration 4: Copolymerization diagram for copolymerization of maleic anhydride (MSA) with F8H2MA (-), methyl methacrylate¹ (---), methyl acrylate² (....) and styrene¹ (-•-)

1: Mayo F. R., Lewis F. M., Walling C. J. Am. Chem. Soc., 70 (1948) 1529

2: Rätzsch M. Arnold M., J. Macromol. Sci.-Chem., (1987) 507

Preparation of P(MAR_{F}-co-MSA) with Simultaneous Charging of Monomers at Start

Acrylates and methacrylates were prepared by a first method by simply adding the monomers together at the start of the polymerization for comparison with prior art processes.

Experimental Prescription

AIBN (4 mol %, based on fluoromonomer), maleic anhydride and fluorinated acrylate or methacrylate monomer are dissolved in 20 ml of ethyl methyl ketone or a mixture of ethyl methyl ketone and hexafluoroxylene (table 5) in a screw top jar equipped with a septum. The solvent is devolatilized and purged with argon to displace oxygen. The reaction solution is stirred at 60° C. in a shaker and precipitated with methanol. The polymer is filtered off and dried at 80° C. under reduced pressure.

TABLE 5
Composition of reactants used and solvent mixtures for
copolymerization of acrylates/methacrylates with maleic anhydride

| | | | | MSA_{ploymer} | |
|---|---|---|---|---|---|
| | | Fluoro- | MEK: | (elemental | |
| | MSA_{Feed} | monomer_{Feed} | HFX | analysis) | Yield |
| Monomer | [mol %] | [mol %] | [parts] | [mol %] | [%] |
| F8H2MA | 30 | 70 | 10:0 | 7 | 59 |
| F8H2MA | 30 | 70 | 8:2 | 8 | 63 |
| F8H2MA | 30 | 70 | 5:5 | 10 | 80 |
| F8H2MA | 50 | 50 | 10:0 | 12 | 76 |
| F8H2MA | 50 | 50 | 8:2 | 16 | 67 |
| F8H2MA | 50 | 50 | 5:5 | 15 | 71 |
| F8H2MA | 66 | 33 | 10:0 | 32 | 76 |
| F8H2MA | 66 | 33 | 5:5 | 31 | 79 |
| F8H2MA | 75 | 25 | 5:5 | 34 | 60 |
| HFPO3MA | 66 | 33 | 5:5 | 30 | 50 |
| HFPO3MA | 75 | 25 | 5:5 | 36 | 45 |
| HFPO5MA | 66 | 33 | 2:8 | 25 | 46 |
| F8H2A | 30 | 70 | 10:0 | 8 | 50 |
| F8H2A | 30 | 70 | 8:2 | 8 | 46 |
| F8H2A | 50 | 50 | 10:0 | 13 | 44 |
| F8H2A | 50 | 50 | 8:2 | 13 | 39 |
| F8H2A | 50 | 50 | 5:5 | 15 | 40 |
| F8H2A | 66 | 33 | 5:5 | 33 | 50 |

F8H2MA: 1H,1H,2H,2H-perfluorodecyl methacrylate
F8H2A: 1H,1H,2H,2H-perfluorodecyl acrylate
HFPO3MA: 1H,1H-perfluoro-2,5-dimethyl-3,6-dioxadodecyl methacrylate
MSA: maleic anhydride

The experimental products were partly nonuniform in their composition, as expected from the copolymerization parameters for methacrylates and maleic anhydride. Very broad molecular weight distributions (M_{w}/Mₙ>>2) are observed, the average molecular weight decreasing with increasing maleic anhydride in the monomer mixture (see illustration 5). The illustration also shows that the molecular weights obtained depend on the composition of the solvent. The higher the polarity of the solvent mixtures used and the poorer accordingly the solubility of the MA-R_{F} monomers, the greater the molecular weight limiting effect of the maleic anhydride added.

[image]

Illustration 5: Plot of molecular weights of P(F8H2MA-co-MSA) against MSA feeds. MEK:HFX=50:50 (Δ), MEK:HFX=80:20 (∇), MEK=100 (⋄), MEK:HFX=50:50 (F8H2MA homopolymer) (□)

The comonomer composition is found to be nonuniform as well as the molecular weight. The fraction of MA-R_{F}-rich polymer chains depends on the weight of maleic anhydride used and on the composition of the solvent. Increasing the maleic anhydride fraction depresses the fraction attributable to fluorohomopolymer or fluorine-rich polymers. To estimate the fraction of MSA-rich copolymers, the solubility/emulsibility of the samples in ammoniacal water was determined. To this end, the individual polymer samples were taken up in ammonia water and the soluble residue was removed. The water-soluble fraction consists of MSA-rich copolymers. The residues consist of fluorine-rich polymers, as can be shown by IR spectroscopy (ester band) and elemental analysis.

[image]

Illustration 6: Plot of fraction of insoluble residue of F8H2MA-MSA) copolymer against MSA fraction. MEK:HFX=50:50 (Δ), MEK:HFX=80:20 (∇), MEK=100 (⋄), MEK:HFX=50:50 (HFPO3MA) (□)

Self-Emulsification Example

Polymerization with Continuous Metered Addition of (meth)acrylate Monomer

To achieve a uniform composition for the copolymers, the copolymerization of the perfluorocarbon-substituted methacrylates with maleic anhydride was carried out by continuous metered addition. According to the copolymerization diagram, high maleic anhydride fraction can be achieved by initially charging 90 mol % of maleic anhydride and continuously replenishing the amount of methacrylate and maleic anhydride consumed during the reaction. To do this one has to know not only the copolymerization parameters but also the polymerization rate.

Experimental Prescription for Determining Time-Conversion Curves and the Initial Polymerization Rates for p(F8h2MA-co-MSA)

AIBN (4 mol %), maleic anhydride and fluorinated methacrylic monomer are dissolved in 20 ml of a 1:1 mixture of ethyl methyl ketone and HFX in a two-neck flask. The solvent is devolatilized by repeated freezing, evacuating and thawing. A septum through which samples can be taken for determining conversion is substituted for one stopper under a countercurrent stream of nitrogen.

| MSA:F8H2MA | AIBN | MSA | F8H2MA |
|---|---|---|---|
| [parts] | [mg] | [mg] | [mg] |
| 25:75 | 33 | 123 | 2000 |
| 50:50 | 49 | 368 | 2000 |
| 75:25 | 99 | 1105 | 2000 |
| 10:90 | 247 | 3207 | 2000 |

Illustration 7 shows two time-conversion curves for the copolymerization of F8H2MA and maleic anhydride (MSA) at different compositions. The measured points were fitted by means of formula (2). Fitting parameters are the maximum possible conversion Uₘₐₓ, the polymerization rate constant v and the polymerization time t.

Conversion=Uₘₐₓ·[1−e^{-v·t}] (2)

The two graphs have the same initial gradients, i.e., the rate at which the polymer is formed is similar in the two cases. To determine the polymerization rate for later metered addition experiment, the gradient of four measured points at a time was determined by linear regression (illustration 8).

[image]

Illustration 7: Time Conversion Curves for Copolymerization of F8H2MA and Maleic Anhydride (MSA)

[image]

Illustration 8: Initial Rates at Various Starting Compositions of the Monomers

With the exception of the gradient at threefold excess of fluorinated methyl methacrylate (m=0.38%/min), all other compositions with at least 50 mol % of maleic anhydride have a gradient of 0.17%/min. The addition of maleic anhydride reduces the polymerization rate. Maleic anhydride reactivity becomes rate-determining at a maleic anhydride fraction of 50 mol % or more.

Initiator concentration and solvent quantity were varied in a further experiment. Doubling the initiator concentration causes the polymerization rate to rise to 0.25%/min. When the monomer concentration is increased for the same amount of initiator, the polymerization rate rises to a value of 0.30%/min. When WAKO V-601® (dimethyl 2,2′-azobisisobutyrate) initiator is used, there are no significant changes compared with AIBN. The initial polymerization rates remain between 0.20%/min and 0.24%/min.

The values determined above can be used to calculate the amounts of maleic anhydride (MSA) and fluorinated methyl methacrylate (MMA) which have to be added in order that polymers having a constant maleic anhydride content may be obtained.

$${R}_{p}^{1} = \frac{{m}_{o}}{V} \cdot \frac{{R}_{pμ}}{100 \%} \cdot \frac{1}{{M}_{1}} \cdot \frac{1}{1 + \frac{{M}_{2}}{{M}_{1}} \cdot \frac{{R}_{p}^{2}}{{R}_{p}^{1}}} \qquad ( 3 )$$

where:

$$\frac{{R}_{p}^{1}}{{R}_{p}^{2}} = \frac{1 + {r}_{1} \cdot \frac{{f}_{1}}{{f}_{2}}}{1 + {r}_{2} \cdot \frac{{f}_{2}}{{f}_{1}}}$$

mₒ=m₁+m₂=total mass of monomers used

V: volume of monomer solution

R_{pμ}: net polymerization rate in %/time

Mᵢ: molar mass of monomer i

fᵢ: mole fraction of monomer i in monomer mixture

From (5) the mass of monomer consumed per unit time, Δᵢ, is given as

Δ₁=V·M₁·Rₚ¹ (4)

Δ₂=V·M₂·Rₚ² (5)

The amount of initiator added can be calculated from the known decomposition constant k by the formula

$$\frac{ⅆ {m}_{i}}{ⅆ t} = k \cdot {m}_{1} \qquad ( 6 )$$

The exact amounts added and addition rates for the polymerization runs (table 6) were calculated according to formula (3-6), wherein monomer 2 is maleic anhydride.

Experimental Prescription:

AIBN, maleic anhydride and fluorinated methacrylate monomer are dissolved in 15 ml of a 1:1 mixture of ethyl methyl ketone and fluorinated cosolvent in a two-neck flask. The solvent is devolatilized by repeated freezing, evacuating and thawing. A septum is substituted for one stopper under a countercurrent stream of nitrogen. The amounts of monomer calculated according to (5) and (6) and also 4 mol % of AIBN are dissolved in 5 ml of MEK/cosolvent and devolatilized (see above) in a septum-sealed glass bottle. The metered addition is carried out with an injection pump for several hours at a constant rate (R_{pμ} see table 6).

Absolute values of the copolymer composition were determined by ¹H NMR analysis and CHF elemental analyses. Table 6 summarizes the results. The data obtained by elemental analysis agree very well with the expected values.

TABLE 6
Monomer, initiator and transfer agent weights and yields of copolymerizations carried out

| | | | | | | | | | | MSA | | Fluorine |
|---|---|---|---|---|---|---|---|---|---|---|---|---|
| | | | | | | | | | | (from | MSA | (elemental |
| | | | Fluoro- | R_{pμ} | Solvent | | | Transfer | | copo | (elemental | analysis) |
| | | MSA | monomer | [% | [1:1 | | Initiator | agent | Yield | diagram) | analysis) | [% by |
| # | Monomer | [mg] | [mg] | min⁻¹] | mixtures] | Initiator | [mg] | [mg] | [%] | [mol %] | [mol %] | weight] |
| 1 | F8H2MA | 61 | 1000 | 0.41 | MEK/HFX | AIBN | 16 | — | 59 | 8 | 3 | 60.37 |
| 2 | F8H2MA | 184 | 1000 | 0.17 | MEK/HFX | AIBN | 25 | — | 100 | 15 | 15 | 58.80 |
| 3 | F8H2MA | 553 | 1000 | 0.17 | MEK/HFX | AIBN | 49 | — | 100 | 28 | 27 | 56.84 |
| 4 | F8H2MA | 1658 | 1000 | 0.17 | MEK/HFX | AIBN | 123 | — | 94 | 40 | 48 | 51.89 |
| 5 | F8H2MA | 1658 | 1000 | 0.17 | MEK/HFX | AIBN | 62 | — | 85 | 40 | 41 | 53.82 |
| 6 | F8H2MA | 1750 | 1000 | 0.24 | MEK/HFX | AIBN | 123 | — | 100 | 43 | 49 | 51.58 |
| 7 | F8H2MA | 1658 | 1000 | 0.24 | CCl₄ /HFX | AIBN | 123 | CCl₄ | 100 | 40 | 47 | 52.13 |
| 8 | HFPO5MA | 1000 | 1000 | 0.15 | MEK/HFX | AIBN | 74 | — | 60 | 40 | 28 | 59.9 |
| 9 | F8H2A | 568 | 1000 | 0.24 | MEK/HFX | AIBN | 51 | — | 28 | 28 | 28 | 58.13 |

The polymers obtained were characterized in respect of their molecular weights by GPC (PSS-SDV-XL columns [Polymer Standard Services Mainz, 2×8×300 mm, 1×8×50 mm, particle size 5 μm], Polymer Laboratories PL-ELS-1000 detector against narrowly distributed polyisoprene standards (PSS)] in Freon and in respect of their melting and glass transition temperatures using a Perkin-Elmer DSC-7 heat flux calorimeter (table 7).

TABLE 7
Molecular weights and melting or glass transition points of synthesized
fluorocopolymers

| | | MSA | | | | | |
|---|---|---|---|---|---|---|---|
| | | (elemental | | | | | |
| | | analysis) | Mₙ | M_{w} | | | |
| # | Monomer | [mol %] | [kg/mol] | [kg/mol] | M_{w}/Mₙ | T_{g} [° C.] | Tₘ [° C.] |
| 0 | F8H2MA | 0 | 8.4 | 14.0 | 1.7 | — | 78.0 |
| | homo- | | | | | | |
| | polymer | | | | | | |
| 1 | F8H2MA | 3 | 162.0 | 233.2 | 1.4 | — | 79.1 |
| 2 | F8H2MA | 15 | 91.7 | 132.4 | 1.4 | — | 92.7 |
| 3 | F8H2MA | 27 | 65.0 | 114.8 | 1.8 | — | 108.7 |
| 4 | F8H2MA | 48 | —^{a} | —^{a} | —^{a} | — | 153.0 |
| 5 | F8H2MA | 41 | —^{a} | —^{a} | —^{a} | — | — |
| 6 | F8H2MA | 49 | —^{a} | —^{a} | —^{a} | — | — |
| 7 | F8H2MA^{d} | 47 | —^{a} | —^{a} | —^{a} | — | — |
| 8 | HFPO5MA | 28 | — | — | — | −36.3 | — |
| 9 | F8H2A | 28 | 13.1 | 25.3 | 1.9 | — | 84/94- |

^{a}Sample insoluble in Freon
^{d}Solvent used in polymerization: HFX:CCl₄ = 1:1

In this case too the molecular weights of P(F8H2MA-co-MSA) polymers decrease with increasing maleic anhydride fraction in the reaction solution and hence in the polymer. Extrapolating the molecular weight values for maximum maleic anhydride (MSA) contents gives an M_{w} of about 90 000 g/mol (see illustration 9). Polymers having a maleic anhydride content of 40% are no longer soluble in fluorinated solvents (Freon 113, HFX) alone, but only in mixtures with polar solvents (acetone, MEK, THF).

[image]

Illustration 9: Weight Average Molecular Weights of Samples 1 to 3 and Extrapolated Value for Sample 4

Illustration 10 is a graphic summary of the dependence of the melt transitions of the P(F8H2MA-co-MSA) polymers on the maleic anhydride (MSA) fraction. There is a distinct increase in the transition temperatures as MSA content increases.

[image]

Illustration 10: Melting Temperatures of P(F8H2MA-co-MSA) Polymers Against Maleic Anhydride Fraction in Polymer

Solubility and emulsibility of P(MSA-co-F8H2MA) in Water

The copolymers were taken up in aqueous NH₄OH solution by hydrolysis of the maleic anhydride groups (table 8).

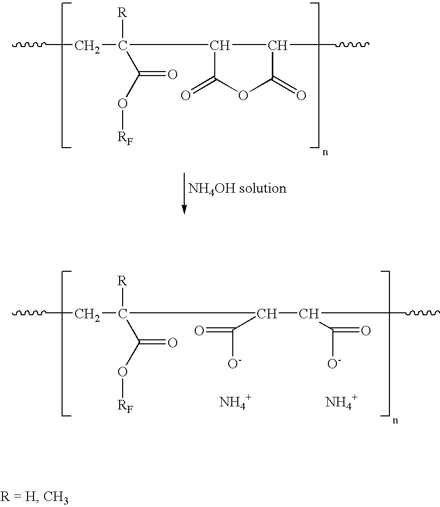

Experimental Prescription:

Method A: Aqueous emulsions of copolymers having fluorinated acrylates and methacrylates were produced by stirring the polymer samples in 10% ammonia solution in a sealed vessel at 60° C. The mixture is subsequently homogenized with an ultrasonicator for about 20 min (Bandelin HD 60). Remaining NH₃ is driven off at 70° C. in a nitrogen stream. Removal of any insolubles (<2% by weight of starting weight) leaves clear, colorless solutions.

Method B: A 10% by weight mixture of sample 7 in aqueous 10% ammoniacal solution is treated at 60° C. for 4-6 hours. The ammonia is subsequently driven off before the mixture is homogenized for a few minutes at about 1000 bar with an Emulsiflex C5 (from Avestin).

Binary P(F8H2MA-co-MSA) copolymer samples having a maleic anhydride content >40 mol % or acrylate polymers (maleic anhydride >28 mol %) were successfully dissolved in aqueous ammonia solution or in water-ethanol mixtures. Clear or opaque, viscous emulsions are obtained depending on the amount of polymer (1-10% by weight). Even cloudy samples show no tendency to phase-separate for days and weeks. The preparation of such stable dispersions without use of a low molecular weight surfactant is novel (see page 3).

TABLE 8
Solutions/emulsions of poly(F8H2MA-co-MSA) copolymers
in water after dispersion in NH₄OH/H₂O

| | | 10% | | SolidsZZ | |
|---|---|---|---|---|---|
| | Copolymer | NH₄OH/H₂O | Ethanol | content | |
| #ZZ | [mg] | [mg] | [mg] | [wt-%] | |
| 7 | 10 | 1990 | — | 0.5 | clear solution |
| 6 | 10 | 990 | — | 1 | opaque |
| 7 | 10 | 990 | — | 1 | clear solution |
| 12 | 10 | 990 | — | 1 | clear solution |
| 7 | 20 | 980 | 1000 | 1 | clear solution |
| 7 | 20 | 980 | — | 2 | opaque |
| 7 | 50 | 950 | — | 5 | opaque |
| 7 | 100 | 900 | — | 10 | opaque/viscous |
| 7 | 150 | 850 | — | 15 | opaque/viscous |
| 7 | 200 | 800 | — | 20 | gel |
| 7 | 300 | 700 | — | 30 | gel |
| 7 | 400 | 600 | — | 40 | gel |
| 16 | 10 | 990 | — | 1 | clear solution |
| 16 | 100 | 900 | — | 10 | clear gel |

Contact Angle Measurements

Thin films of the inventive binary copolymers were spun coated-onto glass plates from a 1% by weight solution or emulsion in water for surface characterization. Clear films were obtained in all cases. The wettability of these films by a series of n-alkanes was determined according to the method of the sessile drop. A G40 goniometer from Krüss with temperature control chamber, G1041 video measuring system and PDA 10 software was used. The values for the critical surface tension γc were determined by means of the Zisman equation and according to the Girafalco-Good-Fowkes-Young equation (table 9).

All polymers have extremely low γ_{c} values below 10 mN/M. The polymer applied from water and annealed does not quite achieve the low value which is observed on deposition from an organic solvent. The reason is that the copolymers do not form a homogeneous film on deposition from water. An improvement can be achieved by subjecting the films to a thermal treatment and by introducing a third comonomer. The latter solution makes it possible to significantly lower the glass transition temperature and melting temperatures of the polymers and thus to achieve effective absorption of the soil- and water-repellent layer at relatively low temperatures.

TABLE 9
Critical surface tension γ_{c} (after Zisman) and dispersive
component of surface energy γₛ^{D} (after GGFY)
and also the contact angles against hexadecane and water

| | γ_{c} | γₛ^{D} | θ_{hexadecane} | θ_{water} | Solvent for |
|---|---|---|---|---|---|
| # | [mN/m] | [mN/m] | [degree] | [degree] | coating |
| 0 | 6 | 9 | 84 | 119.3 | HFX |
| 1 | 6 | 10 | 79 | — | HFX |
| 2 | 6 | 10 | 78 | — | HFX |
| 3 | 7 | 10 | 77 | — | HFX |
| 4 | 8 | 12 | 74 | 110 | HFX/THF |
| 5^{a} | 16 | 14 | 65 | 106 | water |
| 9 | 8 | 10 | 80 | 50 | water |

^{a}Annealed at 100° C. for 5 hours

Introduction of Substituents Via Esters, Amides and Imides of MSA Units

The fluorine content in the copolymers can be further increased by esterifying or amidating/imidating a portion of the maleic anhydride (MSA) groups with alcohols or amines having a perfluorinated radical.

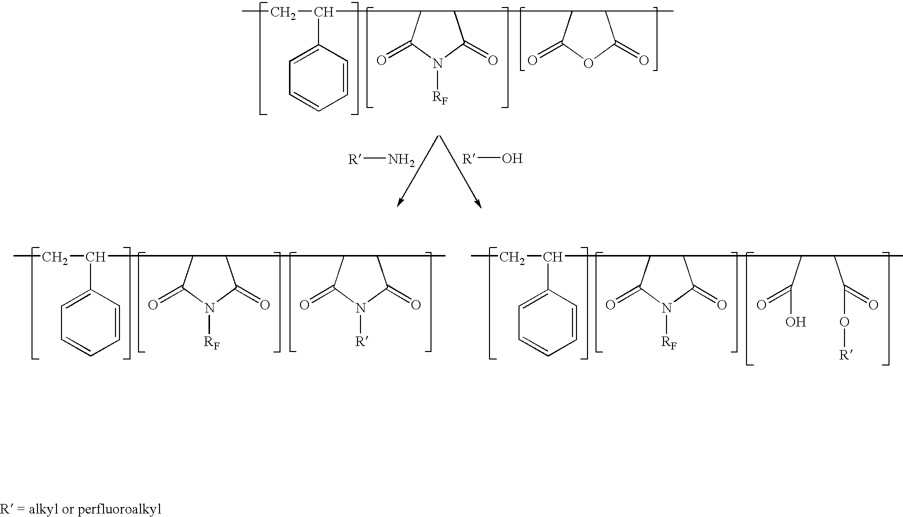

Surprisingly, this leads to an improvement in the solubility/emulsibility and in the absorption characteristics at lower fractions, even though the fraction of hydrophilic carboxylic acid/carboxylate groups is reduced. An explanation is the lowering of the melting temperatures and glass transition temperatures. This lowering of the glass transition temperatures and improved water uptake can also be achieved through amidation/imidation or esterification with nonfluorinated amines and alcohols.

Materials:

Poly(styrene-alt-maleic anhydride) (SMA) having a maleic anhydride content of less than 50 mol % are commercial materials (BASF: Dylark 132, 5.8 mol %, maleic anhydride; Dylark 232 8 mol % maleic anhydride, M_{w}=90 500; Dylark 332, 13.9% MSA, M_{w}=86 500).

Poly(styrene-alt-maleic anhydride) (SMA-S) having a maleic anhydride content of 50 mol % were prepared by free-radical polymerization in methyl ethyl ketone (MEK) and 3-mercaptopropionic acid transfer agent (M_{w}=6100, M_{w}=13 500).

Experimental Prescription for Amidation of SMA with Fluorinated Amines

In a 250 ml three-neck flask equipped with reflux condenser and septum, 1 g of poly(styrene-co-maleic anhydride) (SMA) are dissolved in 100 ml of a mixture of xylene and DMF (˜4:1; depending on the maleic anhydride content of the SMA). After complete dissolution an equivalent amount of fluoramine (depending on the maleic anhydride content or the target fluorine content) is added via a syringe. The solution is stirred at 80° C. for 12 h. Succinamide acid forms. Triethylamine (2 fold excess) and acetic anhydride (1.5 fold excess) are added via a syringe and the reaction solution is stirred at 80° C. for a further 12 h. The solvent is drawn off under reduced pressure, the residue is dissolved in chloroform and precipitated in petroleum ether. The copolymer is filtered off, washed with ether and dried at 80° C. under reduced pressure.

Yield: 80-98%; IR (film, cm⁻¹): 1784 (v C═O anhydride); 1707 (ν C═O imide); 1148-1242 (ν C—F).

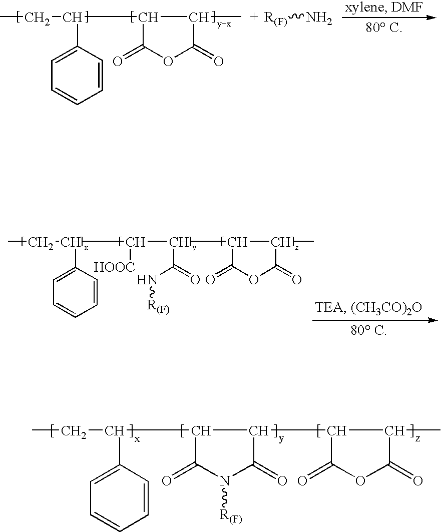

TABLE 10
Graft copolymers obtained by partial imidation of maleic
anhydride (MSA) groups with fluoramines

| | | Fluorine | Fluorine | Residual MSA |
|---|---|---|---|---|
| | M_{w} | content | content | content |
| Graft copolymer | [g/mol] | [mol %] | [wt-%] | [mol %] |
| SMI-H2F8-5 | 6,110 | 5 | 13.1 | 45 |
| SMI-H2F8-10 | 6,110 | 10 | 22.20 | 40 |
| SMI-H2F8-12.5 | 13,500 | 12.5 | 25.78 | 37.5 |
| SMI-H2F8-25 | 13,500 | 25 | 38.04 | 25 |
| SMI-HFPO3-25 | 13,500 | 25 | 37.43 | 25 |
| SMI-H2F8-37.5 | 13,500 | 37.5 | 45.22 | 12.5 |

Stable Emulsions of Partially Fluorinated SMA Copolymers

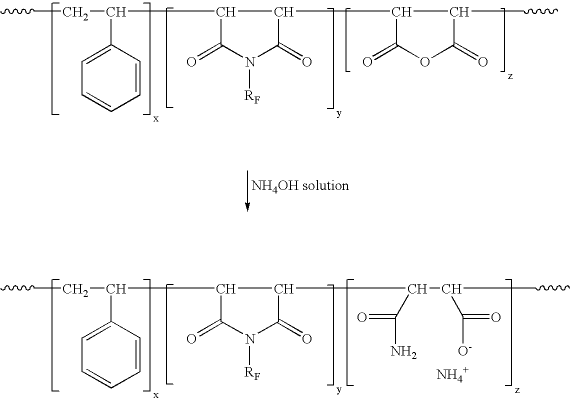

Partly fluorinated SMA copolymers having a fluorine content of at least up to 12.5 mol % (for example SMI-H₂F₈-25; M_{w}=13,500 g/mol) can be emulsified in 10% by weight ammonia water at 60° C., if necessary supported by a cosolvent such as acetone or propyl acetate and an ultrasound treatment.

TABLE 11
Preparation of aqueous solutions of synthesized fluorinated SMA

| | | Fluorine | Residual | |
|---|---|---|---|---|
| | M_{w} | content | MSA content | |
| Graft copolymer | [g/mol] | [mol %] | [mol %] | Remark |
| SMI-H2F8-5 | 6110 | 5 | 45 | clear solution |
| SMI-H2F8-10 | 6110 | 10 | 40 | clear solution |
| SMI-H2F8-12.5 | 13500 | 12.5 | 37.5 | clear solution |
| SMI-H2F8-25 | 13500 | 25 | 25 | clear solution |
| SMI-HFPO3-25 | 13500 | 25 | 25 | clear solution |
| SMI-H2F8-37.5 | 13500 | 37.5 | 12.5 | cloudy |

Investigations of Films Obtained from Inventive Copolymers

Various tests were carried out to investigate the water- and soil-repellent properties of the treated surface.

Preparation of Polymer Solutions

Polymer solutions of various concentrations (0.1 g/l, 1 g/l, 10 g/l) were each prepared in thin layer chromatography separation chambers (23×23×10 cm) by dissolving an appropriate amount of the polymer powder in a 1% solution of ammonia in water.

Cleaning of Surfaces:

The hard surfaces (mirror or ceramic plates) (20×20 cm) were initially thoroughly cleaned with a little washing up liquid (Pril) and distilled water. The surfaces were then rinsed off with ethanol and dried at room temperature.

Raining with Methylene Blue

A glass mirror half coated with an inventive polymer was moistened by dipping in a 0.01% methylene blue solution. After the mirror had been taken out of the solution and placed in an upright position, the run off behavior was evaluated after 30 seconds by directly comparing the two halves of the mirror.

Baked-On Porridge Oats

10 g of an oats porridge were very uniformly brushed onto coated ceramic plates and dried in a drying cabinet at 80° C. for 2 h. To assess soil repellency, the effort needed to remove the stain by mechanical scratching was evaluated.

Burnt-On Milk

In each case 10 g of milk (1.5% fat, UHT, homogenized) were filled into 150 ml glass beakers which had previously been provided with an inventive polymeric coat. The milk stain was dried in a circulating air drying cabinet at 80° C. for 2 h. The stain was subsequently treated with warm water to evaluate its adhesion to the surface.

Coating of Glass or Ceramic Surfaces

To coat surfaces, a 1% by weight solution of a fluorocopolymer in a 1% by weight aqueous ammonia solution was prepared. The solution was subsequently sprayed onto the surface to be coated to produce an aqueous film. The aqueous film was dried to deposit a polymeric film on the surface.

Results:

1.: To coat glass surfaces, a 1% solution of fluorocopolymer 5 was prepared in 1% ammonia. The solution was subsequently sprayed onto a glass pane to produce an aqueous film. The aqueous film was dried to deposit a polymeric film on the glass surface. The polymeric coating exhibited not only water- but also oil-repellent properties in the raining test.

2.: A 1% by weight solution of fluorocopolymer 5 in 1% ammonia was prepared and used for emulsifying 0.1% by weight of fluorocopolymer 4. The emulsion was subsequently sprayed onto a glass pane to produce an aqueous film. The aqueous film was dried to deposit a polymeric film on the glass surface. The polymeric coating exhibited not only water- but also oil-repellent properties in the raining test which were superior compared with 1.

3.: To coat ceramic surfaces, a 1% solution of fluorocopolymer 5 in 1% ammonia was prepared. The solution was subsequently sprayed onto a ceramic surface to produce an aqueous film. The aqueous film was dried to deposit a polymeric film on the ceramic surface. A subsequent bake-on test with oats porridge led to a poor adhesion of the porridge on the ceramic. The solid, baked-on porridge oats were completely removable from the surface by slight mechanical rubbing and also by means of warm water.

4.: A 1% by weight solution of fluorocopolymer 5 in 1% ammonia was prepared and used for emulsifying 0.1% by weight of fluorocopolymer 4. The solution was subsequently sprayed onto a ceramic surface to produce an aqueous film. The aqueous film was dried to deposit a polymeric film on the ceramic surface. A subsequent bake-on test with oats porridge led to a poor adhesion of the porridge on the ceramic. The solid, baked-on porridge oats were completely removable from the surface by slight mechanical rubbing and also by means of warm water. The effect was further improved compared with 3.

Coating of Metallic or Plastics Surfaces

To coat the surfaces, a 0.5% by weight dispersion of a fluoropolymer (composition: 46 mol % of perfluoroalkylethyl methacrylate, 6 mol % of 2-hydroxyethyl methacrylate, 12 mol % of ethylhexyl methacrylate, 36 mol % of maleic anhydride) in a 1% by weight ammonia solution was prepared. To achieve good wetting of the surfaces, the dispersion was admixed with the minimally necessary amount of a silicone-based wetting aid, for example TEGO Wet 280 (Tego Chemie Service, Essen, Germany).

Results:

1.: A special steel sheet and an aluminum sheet were wetted with the dispersion and dried in a drying cabinet at 130° C. to deposit a uniform polymeric film. A raining test showed both samples to have very good resistance to water and oil (hexadecane and heptane).

2.: A piece of polyamide plastic was wetted with the dispersion and dried in a drying cabinet at 110° C. to deposit a uniform polymeric film. A raining test showed the sample to possess very good resistance to water and oil (hexadecane and heptane).

Example of Modification

A) Preparation of Terpolymer

905° mg of AIBN, 12.6 g of maleic anhydride, 187.8 mg of ethylhexyl methacrylate and 7.59 g of F8H2MA were dissolved in 105 ml of ethyl methyl ketone in a two-neck flask. The solvent was deoxygenated by repeated evacuation and purging with argon. A septum was substituted for one stopper of the two-neck flask under a countercurrent stream of argon. 299.9 mg of AIBN, 1.83 g of maleic anhydride, 360 mg of ethylhexyl methacrylate and 14.60 g of F8H2MA were dissolved and devolatilized (see above) in a septum-sealed glass bottle. The solution from the glass bottle was metered into the reaction solution in the two-neck flask at a constant rate for 8 hours by means of an injection pump. The reaction solution was introduced into 300 ml of methanol on completion of the addition. The precipitating polymer was filtered off and dried under reduced pressure.

B1) Modification of Terpolymer Prepared Under A)

2.5 g of the polymer prepared under A) were dissolved in 25 ml of hexafluoroxylene in a 50 ml two-neck flask equipped with reflux condenser. 0.125 ml of N,N-dimethylaminoethanol were added and reacted with the polymer at 80° C. for about 2 h with stirring.

The solvent was subsequently removed in a rotary evaporator. 25 ml of methanol were added and the mixture was stirred for about 2 h to obtain a milky suspension which threw a distinct sediment after being allowed to stand for a few minutes. The polymer was filtered off on a paper filter, washed 4 times with 5 ml of methanol each time and air dried in filter (yield: 2.15 g).

B2) Modification 2

B1 was repeated using N,N-dimethylethylenediamine instead of N,N-dimethylaminoethanol.

C) Destructuring and Dispersing

2 g of the polymer from B1 were dissolved in 200 ml of 5% NH₃ solution by stirring at 60° C. overnight. Ammonia driven off by stirring at 60° C. in an open vessel, any water lost by evaporation being replaced. This gave a slightly cloudy to water-clear dispersion.

D) Preparation of Coating Solutions for Cotton

Solution C) was acidified with acetic acid to a slightly acidic pH (3-5).

The modified terpolymer from F8H2MA, maleic anhydride and ethylhexyl methacrylate exhibited the following behavior on cotton after room temperature drying: a sessile water drop slowly (10 min) became completely absorbed in the fabric, a mineral oil drop was stable for at least 20 min, did not soak in.

The oleophobic/hydrophilic combination had a positive effect on washing behavior. Oily soil adhered very badly and/or was simple to remove: a drop could simply be shaken off without leaving a residue.

The water-resistant properties of the coating were distinctly improved by annealing (pressing iron: 130-160° C., 30 s).

### EXAMPLE

### Lime Soap Soil on Hard Surfaces (tiles)

Lime soap cleaning test: two solutions were prepared, solution I consisted of a solution of 215 g of CaCl₂ in 111 of water (about 2 mol/l), solution II contained 5-7% by weight of sodium oleate (sodium hydroxide was first dissolved in water and a stoichiometric amount of oleic acid was added with stirring). For tests on white tiles or the like, a spatula tip of carbon black was added per 100 ml of solution II in order that the staining was easier to see.

The test samples were divided in two halves by a line. One half served as control, while the other half was appropriately coated or treated with an inventive solution. After coating with an inventive polymer solution, the entire (horizontal) sample was uniformly sprayed first with solution I and directly thereafter uniformly with solution II. A deposit of lime soap formed on the surface. After waiting for 10 seconds the samples were briefly placed upright to allow excess solution to run off. Afterwards, the samples were dried (at room temperature min 12 h or in a drying cabinet) in a horizontal position.

They were cleaned under running tap water. The samples were placed in a customary basin and cleaned with a jet of water impinging centrally on the dividing line from a height of about 40 cm. After 60 s the samples were removed and the soil removal assessed with reference to a semiquantitative scale.

--: distinctly less soil removal than control (untreated surface)

-: less soil removal

0: no difference

+: improved cleaning

++: distinctly improved cleaning, distinctly more soil was removed

The polymer modified under B2 was applied from aqueous solution (a 1% solution was brushed on with a soft hair brush) and tested as described. The polymer exhibits distinctly easier cleaning (++).

Assessment

| Sample | Repellency* | Release* |
|---|---|---|
| Untreated | 5 | 5 |
| Terpolymer: co-MSA- | 2 | 3 |
| F8H2MA-EtHexMA | | |
| Terpolymer: co-MSA- | 2 | 3 |
| F8H2MA-laurylMA | | |

*with regard to aqueous or oily soil

Coating with the inventive fluoropolymers makes for distinctly easier cleaning.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

What is claimed:

1. A copolymer comprising:
a first structural element having Formula I: 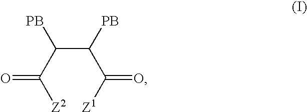
wherein:
PB is a carbon-carbon polymer backbone;
Z¹ and Z² are, independently, O⁻M⁺ or O⁻N⁺(R)₄, wherein M is Na, Li, or K, and R is, independently, H, linear C1-C18 alkyl, an amino sugar, or (CH₂CHR′O)ₘL, wherein m is an integer from 1 to about 20, R′ is, independently, H or a C1-C24 alkyl radical; and L is H, CH₂CHR′N(R′)₂ or CH₂CHR′N⁺(R′)₃;
alternatively, Z² is XR″, wherein X is O or NH, and R″ is, independently, H, R, a fluorine-substituted saturated or unsaturated C1-C18 radical, a fluorine-substituted saturated or unsaturated mono or polycyclic C4-C24 radical, or a fluorine-substituted aryl or heteroaryl C6-C24 radical;
alternatively, Z¹ is X′R″ and Z² is X′R^{N}, wherein X′ is O, S or NR′, and R^{N} is, independently, a C2-C25 alkyl radical substituted with at least one amino group or a C5-C25 cycloalkyl radical having at least one amino group;
alternatively, Z¹ and Z² combine to form NR, NR″, or NR^{N};
and a second structural element having Formula II: 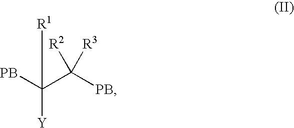
wherein:
R¹, R², and R³ are, independently, H, or C1-C4 alkyl;
Y is R, a fluorine-substituted C1-C24 alkyl radical, a fluorine-substituted cycloalkyl or aryl C6-C24 radical, C(O)OR, a fluorine-substituted C7-C24 alkaryl radical, or a fluorine-substituted alkoxyalkaryl radical;
provided that the copolymer contains at least one fluorine-substituted radical.

2. The copolymer of claim 1, wherein R is aminosorbitol, P-D-glucopyranosylamine or β-D-glucosamine.

3. The copolymer of claim 1, wherein Z¹ or Z² is ONa⁺, NH₄⁺, or XR^{N}.

4. The copolymer of claim 1, wherein Z¹ is ONa⁺ or ONH₄⁺ and Z² is NHR″.

5. The copolymer of claim 1, wherein Z¹ and Z², taken together, are NR″.

6. The copolymer of claim 1, wherein Z¹ and Z², taken together, are other than NR″ or NR^{N}.

7. The copolymer of claim 1, wherein the copolymer has a water solubility of at least 0.1% by weight at 20° C.

8. The copolymer of claim 1, wherein the copolymer comprises at least 10 mol % of the first structural element.

9. The copolymer of claim 1, further comprising a structural element having Formula IV: 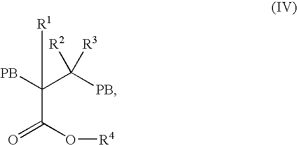
wherein R⁴ is R″.

10. The copolymer of claim 1, wherein the copolymer has a molecular weight of at least 5000 g/mol.

11. The copolymer of claim 1, wherein the copolymer has a fluorine content of at least 5 mol %.

12. The copolymer of claim 1, wherein the copolymer has a polydispersity of less than 7.

13. A composition comprising at least 0.1% of the copolymer of claim 1 by weight of the composition.

14. The composition of claim 13, further comprising water.

15. A process for forming the copolymer of claim 1, the process comprising:
contacting at least one monomer having Formula III: 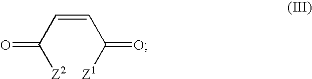
with a monomer having Formula V: 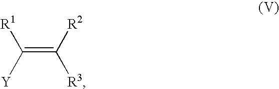
added dropwise during the copolymerization.

16. A process for forming the copolymer of claim 1, the process comprising:
contacting at least one monomer having Formula III: 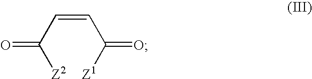
with a monomer having Formula IV: 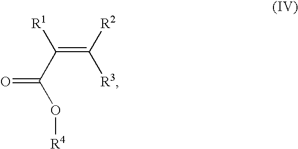
present in excess during the copolymerization.

17. A process for using the copolymer of claim 1, said process comprising:
applying the copolymer of claim 1 to a surface, thereby forming a surface coating.

18. The process of claim 17, further comprising:
decreasing the water solubility or water emulsibility of said copolymer in the surface coating.

19. The process of claim 18, wherein thermal treatment is used to decrease the water solubility or water emulsibility of said copolymer.

20. The process of claim 17, wherein the surface is leather, fabric, or web.

21. The process of claim 17, wherein the surface comprises fabric or web comprising at least one fiber selected from the group consisting of manufactured fiber and natural fiber.
